(19) United States
(12) Patent Application Publication
(10) Pub. No.: US 2003/0182420 A1
(43) Pub. Date: Sep. 25, 2003

(54) Method, system and apparatus for monitoring and controlling internet site content access

(76) Inventors: Kent Jones, Atlanta, GA (US); Rene Campbell, Alpharetta, GA (US); Ian Gaffner, Norcross, GA (US); Doug Spencer, Suwanee, GA (US)

Correspondence Address: Jon M. Jurgovan, Morris, Manning & Martin, LLP, 3343 Peachtree Road, N.E., Atlanta, GA, 30326-1044, US

(21) Appl. No.: 10/152,247

(22) Filed: May 20, 2002

Related U.S. Application Data
(60) Provisional application No. 60/292,502, filed on May 21, 2001.

(51) Int. Cl. G06F 15/173

(52) U.S. Cl. 709/224

(57) ABSTRACT

A disclosed system comprises user sites with monitor devices that report uncategorized content sites requested by users to a master site via an external network such as “the Internet.” The master site administers categorization of content sites, which is carried out by an unknown site reviewer. The master site transmits the resulting site categorization data to the monitor devices. The monitor devices use this data for subsequent user requests to determine categories of content sites requested by users. The monitor device further determines whether users are authorized to access content sites according usage policies established for the users sites.

### TECHNICAL FIELD

The present invention relates generally to monitoring and controlling access to the Internet of users of a computer network, and relates more specifically to providing pass-by flexible access filtering via packet payload monitoring based on content of a site on the Internet and providing rapid categorization via Flexible Access Filtering.

### BACKGROUND OF THE INVENTION

With the advent of companies and homes connecting to the Internet and the World Wide Web (“WWW”), parents and employers have had an increasing interest in monitoring the material viewed by the children in the household and the employees of the company, respectively.

I. Families

I.A. Risk

Children at a young age have shown significant interests in utilizing the WWW and the Internet. Considering the amount of undesirable material that a child can access on the Internet, many parents view the need for monitoring and blocking methods to be of significant importance. Furthermore, additional sites of different types of content are added to the Internet on a daily basis. A parent may desire his/her child to be able to access certain types of content without the fear that the child will view material that the parent believes is unsuitable for the child.

II. Companies

In relation to companies, there are many important reasons to monitor employee usage of the Internet, including at least the following: 1.) minimization of risk of company liability and negative publicity; 2.) maintaining and increasing employee productivity; and 3.) maintaining and increasing the company's network quality of service.

II.A. Risks

II.A.1. Liability and Negative Publicity

When employees abuse Internet privileges, they may expose their company to a variety of adverse consequences, including legal proceedings and liability. Content on the Internet may be offensive to individuals or groups of individuals and can be a source of disruption and even liability for an organization that allows their employees to use such material. For example, many people will find pornographic, racist, hate speech, drug-related, violent, weapon-related, or terroristic content downloaded from the Internet to be offensive. An organization that allows employees to view or distribute such content amongst coworkers may be at risk for legal liability. Of course, accompanying any such incident involving offensive Internet content is the likelihood of negative impact to company morale. Such consequences can have an adverse effect on productivity, the attractiveness of the company to investors, as well as the ultimate success of the enterprise. Furthermore, if the employee's conduct on the Internet results in a claim of liability or becomes public knowledge, the resulting news coverage can adversely impact an organization's business. Therefore, companies have a significant stake tied to controlling their employee's activities on the Internet.

II.A.2. Productivity

According to various recent industry sources, employees currently spend close to twice as much time accessing non-work-related Internet sites as in previous years. As mentioned before, it is likely that in the workplace employees may be squandering anywhere from 30 minutes to three hours a day surfing, trading stocks, chatting, shopping, gambling, listening to music, watching film clips, or playing online games. Clearly, this use of the Internet devours an employee's productivity. It is estimated that one employee wasting an hour a day on the Internet can cost an organization $6,000 a year. For an organization of 500 workers, this lost productivity translates into a $3 million a year problem.

It is estimated that 30 to 40 percent of employee Internet activity is non-business-related and costs companies millions of dollars in lost productivity, according to IDC Research. According to the International Association for Human Resource Information Management (“IAHRIM”) between 19 million and 26 million Americans have access to the Internet at work, where, on average, each spends approximately 6 hours per week online. Charles Schwab, Inc. states that 72 percent of its customers plan to buy or sell mutual funds over the next six months, and 92 percent of these plan to do so online during work hours. The cost to businesses in lost employee productivity from the Internet broadcasts of the Starr report and the Clinton grand-jury video was in excess of $450 million, according to a study reported by ZDNet. Therefore it is understandable why two-thirds of U.S. businesses desire to block and monitor employee Internet usage.

II.A.3. Quality of Service

An organization's network quality of service (QoS) may be one of its most important business assets. QoS refers to the company network's ability to respond to customers' use of the company's network, as well as the needs of company's employees. Today's Internet allows employees to engage in numerous non-work-related activities, such as buying products, chatting with friends, visiting their children at daycare via video-conferencing capability, listening to real-audio feeds, viewing video feeds, and playing interactive games. These non-work-related activities can consume the network's capability. If this happens, customers and employees may experience slow or non-responsive connections when interacting with the company's network. Thus, non-work-related Internet activities can seriously impact the ability of customers and employees to use the network.

### SUMMARY OF THE INVENTION

Stated generally, the present invention comprises a method and an apparatus for Internet Access Management in which sites viewed by employees can be reviewed and categorized through a computer. If site content is deemed to be non-work-related, access to the content can be blocked. Details of the construction and operation of the invention are more fully hereinafter described and claimed. In the detailed description, reference is made to the accompanying drawings, forming a part of this disclosure, in which like numerals refer to like parts throughout the several views.

### BRIEF DESCRIPTION OF THE DRAWINGS

FIG. 1 is a schematic view of an exemplary embodiment of the present invention.

FIG. 2 is a block diagram of the Monitor device.

FIG. 3 is a flow chart representing steps taken by the Packet Capture Software and the Category Daemon.

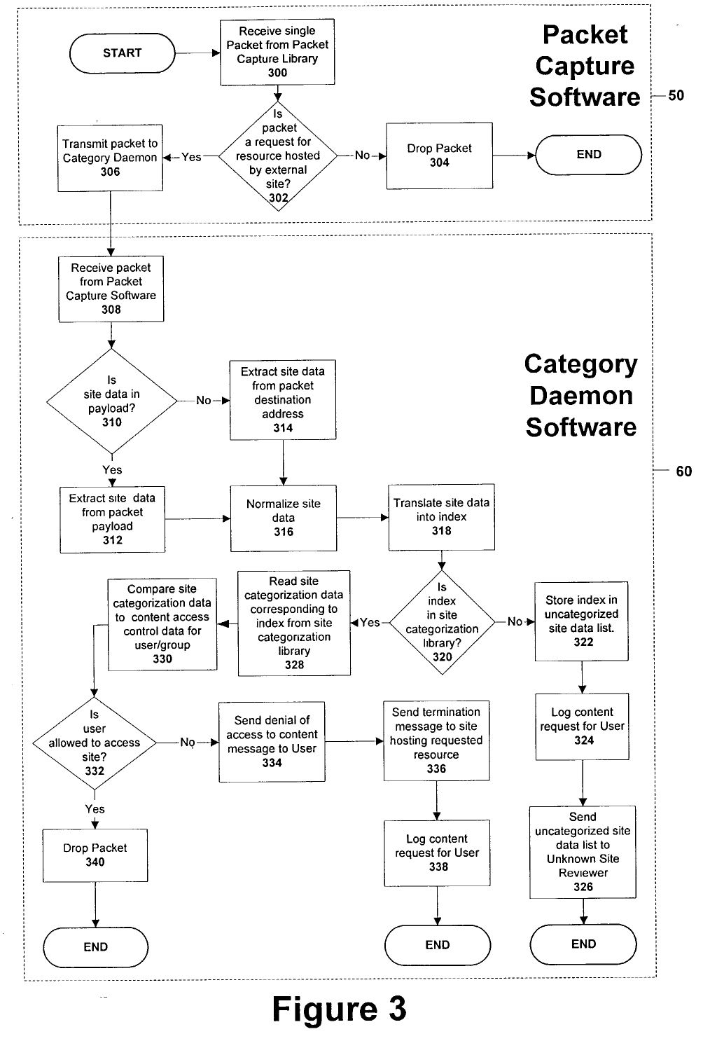

FIG. 4 is view of a typical data packet.

FIG. 5 is a view of a General Information screen shot.

FIG. 6 is a view of a Content Control screen shot.

FIG. 7 is a view of a General Information screen shot.

FIG. 8 is a view of an Exempt Clients screen shot.

FIG. 9 is a view of a Log Settings screen shot.

FIG. 10 is a view of a Device Update screen shot.

FIG. 11 is a view of a User Security screen shot.

FIG. 12 is a view of a System Control screen shot.

FIG. 13 is a view of an embodiment of the Flexible Access Filtering (“FAF”) System.

FIG. 14A is a view of a first embodiment of the steps of the updating the Master Site Categorization List.

FIG. 14B is a view of a second embodiment of the steps of the updating the Master Site Categorization List.

### DESCRIPTION OF THE PREFERRED EMBODIMENTS

III. Internet Access Management

The effectiveness of any Internet Access Management (“IAM”) solution is directly related to the quality and scope of its categorization method. The data concerning Web sites and their content must be accurate, or users will be inappropriately blocked from some sites, and inappropriately given access to others. Another important consideration is that the IAM must also be relevant. For example, there should not be large numbers of unreviewed or uncategorized sites or else large amounts of objectionable content may slip by the filter.

Business 2.0 reported in June 2001 that 41.3 million employees were accessing the Internet, with 34 million being “active” Internet users every week. Business 2.0 also reported fourteen (14) unique sites visited weekly by each employee in an average of eleven (11) unique sessions, with a total of three hundred eighty one (381) page views weekly. It is clear that due to the number of unique sites each employee on average visits, it is very important to keep up with employees surfing habits and the new sites such employees are accessing on an ongoing basis.

The present invention utilizes Flexible Access Filtering. This is a process that preferably uses a bypass monitoring system, preferably analyzes all surfed Web sites for objectionable content and provides flexible access filtering. In a bypass system the packets constituting network communications are “listened” to without “holding” or “queuing” them. Flexible Access Filtering directly addresses the categorization quality and relevance issues and deficiencies found in conventional keyword analysis or list-based filtering applications as it provides accurate content review for all sites actually surfed by users.

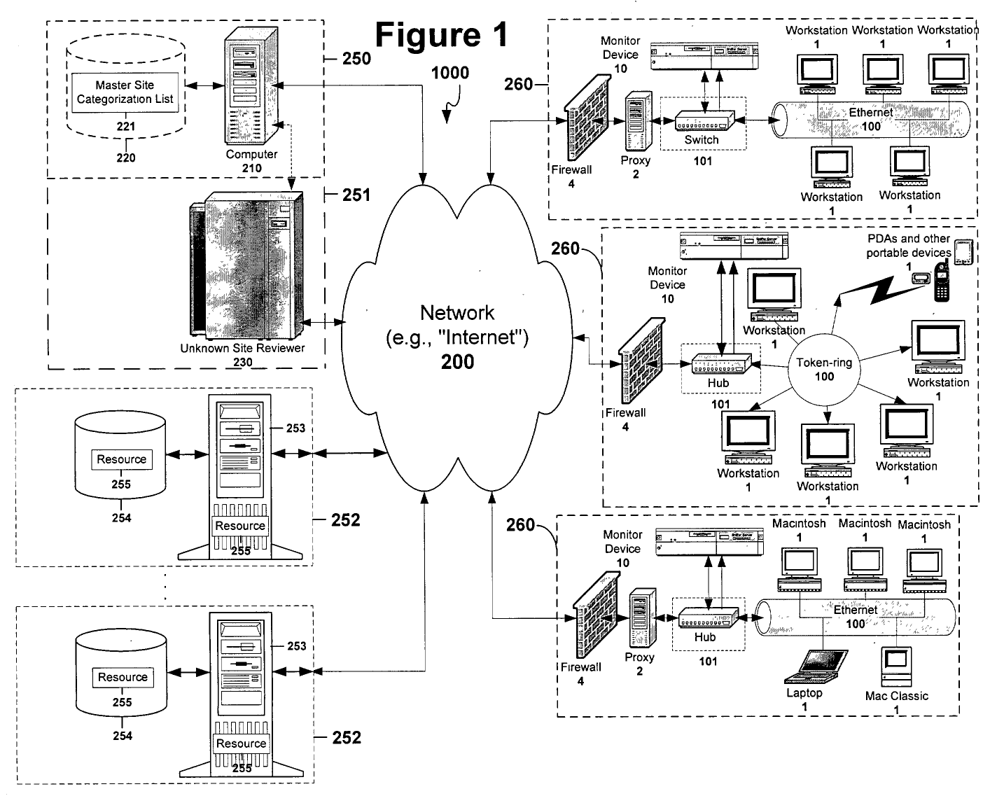

As shown in FIG. 1, Flexible Access Filtering is implemented by a System 1000. The System 1000 comprises a Master Site 250. As used herein, a ‘Site’ is defined as a source and/or recipient of Internet protocol traffic as identified by an internal protocol (IP) address and/or uniform resource locator (URL). The system 1000 can also comprise at least one User Site 260 (three User Sites 260 are shown in FIG. 1). The Master Site 250 and the User Site(s) 260 are operatively coupled to Network 200. Master Site 250 can comprise an Unknown site reviewer 230 coupled to the Network 200. Alternatively, the Unknown site reviewer 230 can be implemented in the System 1000 as a separate Site 251 coupled to Network 200. The system 1000 can also comprise one or more Content Sites 252 that provide content requested by users of the User Sites 260. Each Content Site 252 comprises a server 253 and a content database 254. The server 253 is coupled to the Network 200, and the content database 254 is coupled to the server 253. It should be understood that a User Site 260 may or may not be a Content Site 252 that provides content to users of other User Sites 260. However, to make it easier to describe the System 1000, the Content Sites 252 and the User Sites 260 are shown as separate Sites in the Figures.

The Unknown site reviewer 230 can use one or more different techniques to analyze and categorize content provided by Content Sites 252 over the Network 200 to users of the User Sites 260. These techniques include an automated content recognition engine, optionally using advanced neural network analysis, for review of linked content provided by Content Sites 252 accessed by users of the User Sites 260. Other alternative approaches to categorizing content include human review to accurately determine a category rating for a resource provided by an unknown Content Site 252.

Network 200 is preferably the “Internet” but alternatively can be any network that permits Sites 250, 251, 252, 260 to communicate with one another. This can include intranets and Local Area Networks (LANs), Wide Area Networks (WANs), Metropolitan Area Networks (MANs), Virtual Private Networks (VPNs), wireless networks, and other types of networks.

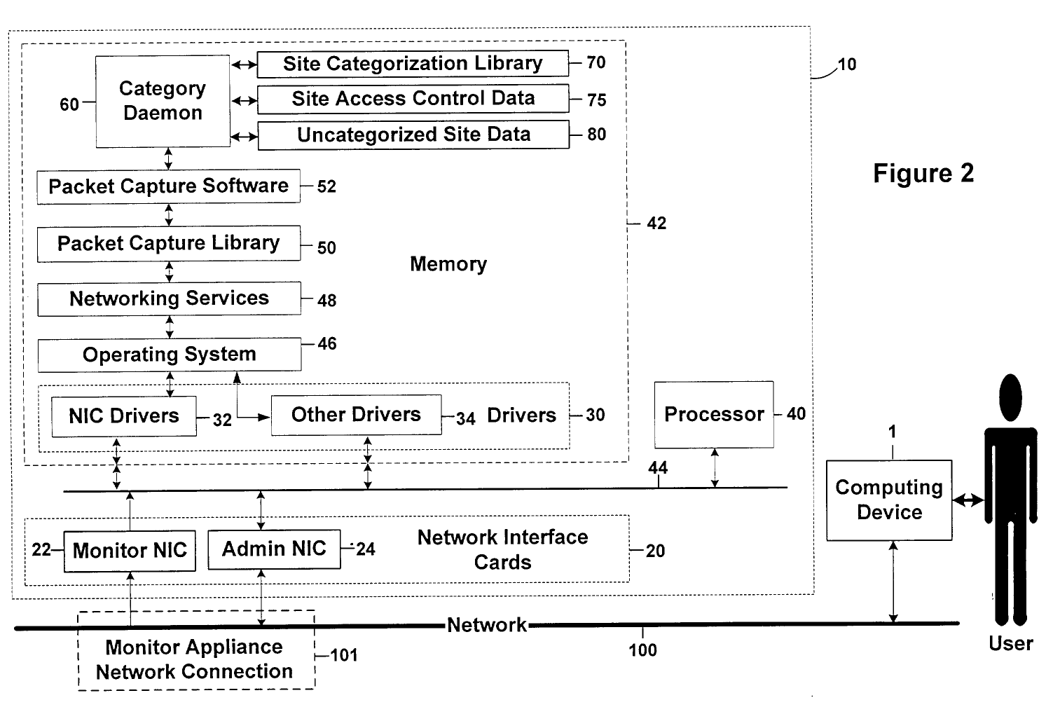

As shown in FIG. 1 and FIG. 2, an important feature of the system 1000 is Monitor device 10. A Monitor device 10 is coupled to the network 100 of each User Site 260 in which access to content via Network 200 is to be monitored. The Monitor device 10 can be provided with a Site Categorization Library 70. The Site Categorization Library 70 may be pre-configured with numerous pre-categorized sites.

As a user of a computing device 1 of the network 100 in a User Site 260 accesses or ‘surfs’ content provided by Content Sites 252 on the Network 200, Monitor device 10 logs sites requested by a user but not found in current Site Categorization Library 70 into Incremental Site Data (“ISD”) list 80. ISD list 80 is then forwarded, preferably daily, to a centralized Unknown site reviewer 230 where each site is reviewed for categorization of the site content. The ISD List 80 can be forwarded to the Unknown Site Reviewer 230 during periods of low-uses of the Network 100, such as non-business hours, to avoid consumption of network resources during the workday. Preferably, the content review process includes categorization of pornographic, racist, hate speech, drug-related, violent, weapon-related, terroristic, and other types of high-risk data. In addition, many other types of content can be classified. Table 1 below includes an exemplary list of categorizations of content accessible to a user:

TABLE 1
Filtering Content Categories

| | | |
|---|---|---|
| Sex Education | Pornography | Mature Content |
| Drugs | Weapons | Hate Speech |
| Violence | Gambling | Tobacco |
| Alcohol | News | Sports |
| Job Search | Hacking | Finance/Investing |
| Society | Shopping | Travel |
| Criminal Skills | Cult and Occult | Personals/Dating |
| Hobbies | Government | Entertainment |
| Games | Health | Automotive |
| Politics/Religion | Reference | Technology |
| Art | Education | Science |
| Consumer Information | Law | General Business |
| Military | | |

It is preferable that within twenty-four (24) to seventy-two (72) hours, the newly categorized sites are automatically distributed to all Monitor devices 10 for update of their respective Site Categorization Libraries 70. However, this time period is not restricted, and the time period for generating and distributing site categorization updates can be as short as one millisecond, if possible, to as long as one year, for example. After update, the Site Categorization Libraries 70 become immediately available for filtering and reporting purposes. This process assists in providing network administrators with an accurate and highly relevant database to establish Internet access policies for the organizations owning or operating User Sites 260.

For purposes of the present disclosure, references may be made to use of the present invention in the context of an enterprise or organization that owns or operates the User Sites 260. It should be appreciated that the content monitoring of the system 1000 is equally applicable to a User Site 260 that is a computer for home use. As yet another alternative, the content monitoring provided by the system 1000 can be extended to a User Site 260 that is an Internet Service Provider (“ISP”) or other point-of-presence on the Network 200, for example.

II.A. Flexible Access Filtering Control

Content is preferably categorized by site name and top-level domain name or Universal Resource Locator (URL). In addition, the file path name following the top-level domain name can be used for categorization. However, to reduce the data processing burden on the Unknown Site Reviewer 230, it is preferred to use only a limited number of directory name or file names in a pathname of a resource. For example, www.bigsite.com/sex could be categorized as pornography. All content below the root directory ‘sex’ can be categorized as pornography as well. Accordingly, upon encountering the root directory ‘sex’ in the content review process, the Unknown Site Reviewer 230 can conclude that the files under such directory are also sex-related. This avoids the need to expend computer-processing capability on reviewing content in files below this directory that can be safely concluded to be sex-related content. One skilled in the art will appreciate that other methods of categorization can be used within the scope of the present invention. In general, reviewing sites for domain name and the root directory or filename immediately thereunder provides sufficient information to classify the content under the root directory. It should be understood that a particular Content Site 252 may host a variety of content, some of which an organization may desire to exclude and other content that should not be excluded. In general, the inventors have found that examination of the URL and first level of the pathname are in most cases sufficient to be able to determine the category of content in a file(s) beneath this level.

The Unknown Site Reviewer 230 preferably categorizes all unknown sites within twenty-four (24) to seventy-two (72) hours. It is preferable that objectionable sites are categorized most quickly, preferably within twenty-four (24) hours. This categorization process is discussed in greater detail subsequently in this document.

The Unknown Site Reviewer 230 can be implemented so that Sites that remain uncategorized by the Unknown Site Reviewer for longer periods are generally those that are not objectionable. For example, if a Content Site 252 does not trigger a categorization via a word search or the like, then the site will likely fall outside of any of the categories. Because the categories generally include all types of content to which user access should be blocked, the Monitor device 10 can be programmed so as not to reject the uncategorized Content Sites that generally do not contain objectionable content.

Preferably, the Flexible Access Filtering implemented in the system 1000 takes an “innocent until proven guilty” approach, and permits requests for unknown sites while they are under review. One skilled in the art will appreciate that because Flexible Access Filtering is driven by the actual user activity of its total user base, the number of unreviewed sites that are requested by a User of the computing device 1 is generally relatively low. This is especially true if the system 1000 is compared to competitive list-based products. Additionally, Flexible Access Filtering proves to be more accurate than keyword scanning. The more users that are accessing or ‘surfing’ content on the Network 200, the larger and more representative the reviewed sites are for those sites actually accessed by users. This decreases, if not eliminates, categorization of sites never accessed, and yet permits categorization of Content Sites 252 that are new or are not linked to, and therefore are discoverable by a search engine by a user of a computing device 1.

For example, those skilled in the art will appreciate that content at many Sites 252 are accessed after a user receives notice of the site by another person. This can be done by electronic mail, Instant Message, or other automated process, as well as conventional means of simply telling another person about a particular Site 252 or content thereon (i.e. “word of mouth.”). When a User of a computing device 1 receives notice of a Content Site 252 that interests such User, the User often shares the content with other Users, who in turn will share it with others, and so on. Hence, categorization of content hosted by a Site 252 is often content requested by multiple Users, even Users that do not use the same User Site 260 to access content at Sites 252 via the Network 200. This phenomenon may significantly reduce the amount of data processing required by the Unknown Site Reviewer 230 because categorization of content requested by one User at a respective User Site 260 may well be content requested by other Users at the same or different User Site.

Within the system 1000, if a Content Site 252 is initially accessed by the user of the computing device 1, it is recorded by the Monitor device 100 in a log file and cataloged by the Unknown Site Reviewer 230 in a relatively rapid manner. Once content of a Site 252 has been categorized by the Unknown Site Reviewer 230, the Unknown Site Reviewer transmits the identity of the Content Site 252 and the hosted content (e.g., URL and pathname for the content file) to the computer 210 of the Master Site 250. If the Unknown Site Reviewer 230 is a separate Site from the Master Site 250, the Unknown Site Reviewer transmits this information via the Network 200. Alternatively, if the Unknown Site Reviewer 230 is an element of the Master Site 250, the Unknown Site Reviewer can transmit this information either directly or via separate network coupling the Master Site 250 and Unknown Site Reviewer 230 to the computer 210. The computer 210 of the Master Site 250 stores the identity of the Content Site 252 and its hosted content in correspondence with its category in the Master Categorization List 220. The Master Categorization List 220 stores this information for all categorized Content Sites 252 accessed by the Users via respective User Sites 260. The categorization information including Content Site 252 and content identity and corresponding category are transmitted by the computer 210 to the User Sites 260 via the Network 200. The Monitor devices 100 of respective User Sites 260 receive the Site and content identity and corresponding category and store this data. The Monitor device(s) 10 apply the Site/content categorization to future and past network access sessions to determine whether requested content should be blocked if access to the content is in progress. If so, the Monitor device 10 blocks access to the computing device 1 operated by the User to access the restricted content.

The Monitor device(s) 10 can perform this function in the following manner. The Monitor device 10 sends a message to the computing device 1 to block access to the content site. For example, the message can be in the form of a redirect message that directs a web browser executed by the computing device 1 to an HTML document that indicates that the user is not authorized to access the content site under the network usage policy of the organization associated with the network. In addition, the Monitor device 10 can transmit a message to the Content Site 252 to terminate any further transmission of content to the computing device 1. The message can be in the form of a close connection request (e.g., a TCP/IP FINISH request). The Monitor device(s) 10 can be programmed to assign responsibility for network access activities to respective Users of the User Sites 260. More specifically, the identity of the Content Sites 252 and their hosted content that User 1 has attempted to access can be recorded or logged by the Monitor device 10. Once the site content has been categorized, the network “access” log is updated to reflect the category of the site and content accessed by a User 1. Because responsibility for network activity associated with accessing network content can be assigned to and tracked by User, appropriate corrective action can be taken with a User that has been accessing network content deemed inappropriate. In addition, if Users are aware that their network activities can be monitored and the identities of the Sites and content Users access are recorded at the User Site 260, Users will be deterred from accessing inappropriate content. This can have a very positive effect on maintaining a positive work environment for the Users as well as to enhance their productivity.

It should be appreciated that the system 1000 can accommodate numerous Users at the User Sites 260. If there are numerous Users, the network content sought by the Users will approximate the content sought by the public at large. By categorizing only that network content that is actually sought by the Users, significant savings in terms of data processing capability is achieved because content that is not accessed is not categorized. Given the myriad web pages and other content accessible on the Internet, it will be appreciated that the approach used by the system 1000 is vastly superior to previous approaches that attempt to categorize every web page on the Internet, most of which will never be sought be a User.

Although a User can request unknown sites for the period during which the respective Monitor device 10 and/or Unknown site reviewer 230 is determining the category (if any) under which User-requested content should be categorized, the category that is assigned will preferably be used for later reporting and the users can be held accountable for their policy violations. This is in contrast to conventional list or keyword-based methods. These methods may never block or report on the site if it is not found and manually tagged as objectionable, or detected as objectionable by a generic keyword scan. This creates a false sense of security on behalf of the organizations operating the User Sites 260 and may perpetuate undesirable behavior by employees.

III.B. Flexible Access Filtering Advantages

As previously mentioned, the disclosed system 1000, Monitor device 10, and methods of the invention use Flexible Access Filtering which offers many advantages over previous categorization techniques, including list-based, keyword analysis and on-site content analysis approaches. These advantages include:

III.B. 1. Relevance

As previously discussed, Flexible Access Filtering as implemented in the system 1000, Monitor device 10, and methods ensures positive categorization for Internet content for which access is actually sought by Users of the User Sites 260, including obscure sites that would not normally be identified in a scan of the Web. This avoids a major drawback of list-based filters, which provide a list of sites the developers believe or predict will be accessed by Users. In reality, organizations using such list-based filter products discover that a significant portion of their Web traffic is never reviewed or made available for access management. As Flexible Access Filtering is driven by real-world network activity of many users in the preferred case, the disclosed system 1000, Monitor device 10, and methods provide a highly focused and relevant access-control foundation.

III.B.2. Consistency

Typically, a person reviewing sites can only handle at most a few hundred sites per day. Additionally, no two reviewers will categorize the same list of sites with one hundred (100) percent consistency. Flexible Access Filtering's automated content recognition of categorizes content with a relatively high degree of consistency and precision in the disclosed system 1000, Monitor device 10, and methods.

III.B.3. Accuracy

As implemented by the disclosed system 1000, Monitor device 10, and methods, Flexible Access Filtering provides full content review with a relatively high degree of accuracy as compared to crude keyword filters offered by many products. To perform Flexible Access Filtering, the system 1000 can use a sophisticated neural network analysis that overcomes the problems associated with conventional keyword analysis, i.e. poor handling of words used in different contexts, inability to handle image-only or foreign language pages, etc. Flexible Access Filtering's strength in terms of its accuracy allows it to control traffic without over- or under-blocking of network content sought by Users of the system 1000.

III.B.4. Scalability

As implemented by the system 1000, Flexible Access Filtering's centralized content analysis allows it to provide appropriate sophistication and processing power for relatively accurate, high-volume categorization. This allows for comparatively efficient categorization of a much larger volume of traffic than is possible with previous content analysis software installed and maintained at User Sites. Flexible Access Filtering used in the system 1000 also removes the added customer cost of supporting finicky remote analysis techniques. Flexible Access Filtering's combination of full Site review, automated content recognition, and shared customer learning provides superior relevance, accuracy, and control compared to conventional list-based or keyword filter products.

IV. Objects, Features and Advantages of the Present Invention

Some specific objects, features, and advantages of the disclosed system 1000, Monitor device 10, include:

Providing less likelihood of an organization or individual owning or operating a website from being subjected to negative publicity in connection with access of inappropriate content on the Internet;

Assisting in maintaining productivity by making employees aware of the fact that their network activities can be or are being monitored; and

Assisting in protection of Bandwidth and Quality of Service by reducing network traffic on the User Sites that is not work related.

IV.A. Providing Limitation of Negative Publicity and Liability

IV.A.1. Filtering

As previously stated, the use of the disclosed system 1000, monitor device 10, and methods provide network content filtering to reduce and individual or organization's risk and the potential for legal liabilities from Internet misuse. If an organization is provided the tools to selectively block access to high-risk content, such as sites, downloads, or newsgroups featuring pornographic, racist, hate speech, drug-related, violent, weapon-related, or terroristic content, the company can better ensure safe, protected, and policy-compliant access of Internet content by its employees.

IV.A.2. Reporting

The use of graphical, dynamic Internet usage reports can provide an organization's team leaders with customized views that help them manage the risks associated with employee Internet use.

Other objects, features or advantages of the present invention in relation to providing limitation of negative publicity and liability include:

Blocking options for small, medium, or large companies;

Categorization of many URLs (and first level filepath names if present) (as many as thousands or more);

Blocking of the “Web's Worst” URLs;

Monitoring and reporting on reasonable Web usage;

Identification of non-work-related surfing;

Identification of users and sites they accessed;

Identification of the worst Internet offenders;

Categorization of sites to be added daily and capable of blocking content sites within hours of going online; and

Combinations thereof.

IV.B. Assistance in Maintaining Productivity

There is a need to provide URL filtering and comprehensive reporting, as well as a combination thereof.

IV.B.1. Filtering

An organization can use tools in the Monitor device 10 to selectively block access to improper Internet activity or to permit access to network content that the organization desires or is not opposed to its employee's access thereof. The organization can implement its network access policy in a manner tailored for the needs of the organization.

IV.B.2. Reporting

The Monitor device 10 can generate easy-to-read graphical, dynamic reports to provide an organization's team leaders with Internet usage reports on departments, individuals or for entire organizations, so that the leaders will be able to assist in ensuring that the organization's Internet access is working for the organization and not against it.

Other objects, features or advantages of the disclosed system 1000, Monitor device 10, and methods of the invention in relation to assisting in maintaining productivity include:

Maximization of productivity by permitting reasonable Web use;

Preservation of morale with selective blocking of network content;

Categorization of many URLs (up to thousands or more);

Blocking of offensive sites and content;

Blocking of non-productive sites and content;

Identification of the sites and content accessed by each employee;

Utilization of reverse DNS lookups to associate site names with IP addresses;

Identification of the heaviest Internet users;

Identification of non-productive download activities;

Identification of most frequently accessed sites;

Categorization of sites to be added daily;

Blocking of new sites rapidly after access is requested;

Blocking of the sites that are an organization's worst productivity draws; and

Combinations thereof.

IV.C. Protects Bandwidth and Quality of Service

In relation to bandwidth there is also a need to provide Internet content filtering and comprehensive reporting, as well as a combination thereof.

IV.C.1. Filtering

An organization can use tools of the Monitor device 10 to selectively block access to high bandwidth Internet use, such as audio, video, MP-3, stock streamers or high-resolution downloads and the like, and be more able to assist in assuring quality of network service.

IV.C.2. Reporting

An organization can use the Monitor device 10 to generate graphical, dynamic Internet usage reports to provide the organization easy-to-read perspectives regarding high impact Internet use that threatens network QoS.

IV.C.3. Other Objects, Features or Advantages

Other objects, features or advantages of the disclosed system 1000, Monitor device 10, and methods in relation to QoS and Bandwidth issues include:

Improvement of QoS by limiting high-bandwidth Internet use;

Selective access blocking to high-bandwidth Internet usage;

Monitoring of acceptable Internet usage for bandwidth optimization;

Analyzing network bandwidth trends;

Analyzing bandwidth consumption by individuals, departments, and protocols;

Analyzing bandwidth impact from HTTP, FTP, Telnet, SMTP, and other protocols;

Evaluation of the number and impact of individuals accessing a network;

Auditing of performance of proxy servers and caching with graphical and tabular information;

Categorization of sites to be added daily;

Blocking of selected sites within hours of the site going online; and

Combinations thereof.

V. Additional Objects, Features or Advantages of the Present Invention

Additional objects, features or advantages of the system 1000, Monitor device 10, and methods include:

Plug and Blocking features;

Ability to provide an invisible router or firewall mode;

Scalability of the system and features;

Denial of access to pre-selected Internet Web sites via HTTP and the like;

Denial of access to pre-selected Internet FTP sites via FTP and the like;

Denial of access to pre-selected Internet Newsgroup sites via NNTP and the like;

Denial of access to pre-selected words within Internet Search Engines;

Automatic filtering of proxy servers to assist in prevention of avoiding filtering and assisting in securing the system;

Integration of Radius module and the like for authentication;

Customization of individual filtering profile of end users;

Capability to utilize VPN and the like;

Supporting of IP Tunneling and the like;

Automatic daily library updates of newly blocked sites;

Selective filtering of categories;

Selective filtering of user/group;

Selective filtering by IP or user name;

Filtering through individual profiles for dynamic IPs;

Detailed reporting of Internet usage by user and/or by organization/group;

Fail-safe routing; and

Supporting of multiple block pages.

### DETAILED DESCRIPTION OF AN EXEMPLARY EMBODIMENT

VI. Overview of the FAF System

As shown in FIG. 1, the system 1000 comprises a master site 250 and at least one User Site 260. The master site 250 can comprise unknown site reviewer 230. Alternatively, the unknown site reviewer 230 can be provided as a separate site 251. The system 1000 can further comprise at least one resource site 252. The Sites 250, 251 (if used in the system 1000), 252, and 260, are operatively coupled in communication with one another via network 200. The network 200 is preferably the Internet or other public network. However, without departing from the scope of the invention, the network 200 may include other types of networks such as intranets or local area networks (LANs), wide area networks (WANs), metropolitan area networks (MANs), virtual private networks (VPNs) or wireless networks, for example.

The master site 250 comprises a computer 210 and data storage unit 220, and can include the unknown site reviewer 230. The computer 210 facilitates communication of unknown sites hosted by the sites 252 requested by users of the User Site(s) 260 to the unknown site reviewer 230 for categorization. After the unknown site reviewer 230 categorizes the site 252, the unknown site reviewer 230 transmits data representing the categorized site along with the identity or uniform resource locator (URL) and any top-level filepath name segment of the content site 252, to the computer 210. The computer 210 stores the data associated with the categorized site in the master site categorization list 221 in data storage unit 220. The computer 210 provides the data indicating the identity or URL and filepath name segment of the requested site 252, and the site's category, to the User Site 260.

Each User Site 260 has at least one computing device 1. The User Site 260 can comprise a network 100 to which the computing device(s) 1 is coupled. The User Site 260 also comprises a monitor device 10. The monitor device 10 is capable of monitoring traffic on the network 100, which may be one of many different kinds of networks such as Ethernet, Token-ring, and the like, as shown in FIG. 1. The User Site(s) 260 can further comprise a monitor device network connection (“MDNC”) 101. The MDNC 101 provides a network connection for the monitor device 10 to the network 100. The MDNC 101 can comprise a hub, switch, or other device through which passes network traffic from computing device(s) 1 that is to be monitored by the monitor device 10. More specifically, the monitor device 10 monitors the network traffic passing through the MDNC 101 for requests for external sites 252 that should be blocked in accordance with rules set for the users of a network 100 by its administrator, for example.

At least one computing device 1 is operatively coupled to network 100 and has access to sites 252 hosting resources 255 via the network 200. The computing device 1 can be one of a variety of different units such as Workstations, IBM Compatibles, Unix Workstations, Macintosh desktops, laptops, Internet appliances, set-top boxes for use with television, personal digital assistants (PDAs), and other portable devices including cell phones, and the like. The computing device 1 provides a user with the ability to access content provided by sites 252 via the network 200.

The network 100 can comprise a proxy server 2. If network 100 includes the proxy server 2 it is preferable to couple the MDNC 101 at a point in the network 100 that is before proxy server 2 in relation to computing device(s) 1. The proxy server 2 acts as an intermediary between a computing device 1 and the network 200. The proxy server 2 can be used to provide security, administrative control, and caching services for the network 100. The proxy server 2 is typically associated with, or is a part of a gateway server (not shown) that separates network 100 on one side from network 200 and firewall server 4 on the other side. One skilled in the art will appreciate that proxy server 2 may not be required, and in circumstances may not even be preferable for use in a network 100.

Firewall 4 is typically a set of related programs located at a network gateway server that protects the devices of network 100 from intrusion by users or devices external to the network 100. Firewall 4 works in conjunction with a router program, that examines each packet received from the network 200 to determine whether to forward it toward its destination device or user in the network 100 in accordance with rules set in the firewall's program(s). The firewall 4 also typically includes or operates in conjunction with proxy server 2 in processing network requests made by users via computing device(s) 1. The firewall 4 can be installed in a specially designated computer or server separate from the rest of the network 100. The firewall 4 is normally coupled to the network 100 so that no incoming request can directly access private network devices without first encountering the firewall to determine whether the request is permitted or is instead an unauthorized activity such as a network intrusion. If the request is unauthorized, the firewall 4 is programmed to block the incoming request to prevent access to the targeted resource on the network 100. As with proxy server 2, firewall 4 may not be required for use in the network 100, and in some implementations may not even be preferable.

Proxy server 2 receives a request for an Internet resource such as a web page document from a user via a respective computing device 1. Proxy server 2, assuming it is also a cache server, searches its local cache for a previously downloaded web page document to determine if the requested web page has been previously stored in the cache. A ‘cache’ is typically a memory that stores data such as a web page on a temporary basis. If proxy server 2 finds the page in its cache, it returns the page to the computing device 1 for presentation to the user via the user interface provided by the computing device 1. If the web page is not in the cache, proxy server 2, acting as a client on behalf of the computing device 1 operated by the user, employs one of its own IP addresses to request the web page from one or more server(s) on the network 200. If the page is returned, proxy server 2 relates the web page to the original request and forwards the web page to the user of the computing device 1. The computing device 1 generates a user interface presented to the user based on the received web page.

To a user of the computing device 1, proxy server 2 appears to be ‘invisible’. In other words, from the perspective of the user, the computing device 1 appears to communicate directly with the resource sites 252 as the user operates the computing device 1 to access content at such sites. In reality, the proxy server 2 translates the IP address of the computing device 1 into a different IP address in the process of accessing content of the sites 252. In fact, the requests and returned responses appear to be directly with the addressed Internet server. One skilled in the art will appreciate that proxy server 2 is not quite invisible because its IP address must normally be specified as a configuration option to the browser or other protocol program executed on the computing device 1.

An advantage of proxy server 2 is that its cache can serve all users of the computing devices 1 on network 100. If resources of one or more resource sites 252 are frequently requested by users of the User Site 260, the files or web pages or other resources provided by the sites 252 are likely to be in the cache of proxy server 2, which improves response time to user requests.

The functions of proxy server 2, firewall 4, and the previously mentioned caching capability, can be provided by separate server programs or can be partly or wholly combined together in one or more modules or devices. As one skilled in the art will appreciate, if firewall 4 and proxy server 2 are combined, it would be preferable to connect MDNC 101 in the network 100 between the computing devices 100 on one side and the combination of firewall 4 and proxy server 2 on the other side. One skilled in the art will appreciate that the functions of monitor device 10 can be combined with those of proxy server 2 and/or firewall 154, as one or more than one device, without departing from the scope of the invention.

If the MDNC 101 is placed between network 200 and proxy server 2, the proxy server 2 sends a request to network 200, monitor device 10 is coupled to MDNC 101 to monitor network traffic passing there through by examining the packet(s) that constitute a part of the request. Normally, unlike the firewall 4 that monitors requests originating from network 200 inbound to the network 100, the monitor device 10 monitors outbound requests originating from a computing device 1 on the network 100 to request access to a web page or other resource hosted by a destination site 252. If the monitor device 10 examines a request and determines that the request is for a destination site 252 that is not in a category compliant with the rules programmed into the monitor device, the monitor device blocks the request and transmits a rejection message to the proxy server 2. The proxy server 2 caches the rejection message and forwards such message on the network 100 to the computing device 1 and/or user from which the request originated. In addition to the rejection message, the monitor device 10 sends a termination request to the requested site 252 hosting the resource sought by the user. In response to the termination request, the site 252 stops transmission of the requested resource to the computing device 1 of the requesting user. The user is thus prevented from accessing a site or a resource hosted by such site if prohibited by the rules set in the monitor device 10.

In the process of determining whether a user and/or computing device 1 is authorized to access a particular site 252, the monitor device 10 uses a site categorization library 70. The site categorization library 70 includes a list data indicating sites 252 previously categorized by the unknown site reviewer 230 and transmitted to the monitor device 10. If the monitor device 10 determines that a requested site 252 has not been categorized in the site categorization library 70, the monitor device 10 stores the data indicating the identity or network address (e.g., URL) of the requested site 252 and any associated filepath segment, as uncategorized site data 80. The monitor device 10 transmits the uncategorized site data 80 at intervals or periodically to unknown site reviewer 230 via network 200. The unknown site 10 reviewer 230 can combine similar requests for uncategorized site data 80 from the monitor device(s) 10 of other networks 100 in the system 1000 for efficient handling of the requests and to eliminate redundant requests for the same site 252. The unknown site reviewer 230 categorizes the unknown site(s) 252 identified by the monitor device(s) 10 in the uncategorized site data 80. The data indicating the newly categorized site(s) are compiled by the unknown site reviewer 230 and are transmitted to update computer 210. The update computer 210 can record data indicating the identity and/or network address of the requested site 252 and the corresponding site category, in a master site categorization list 221 stored in data storage unit 220. At intervals or periodically (for example, on a daily basis), the monitor device 10 establishes a connection via the network 200 for communication with the update computer 210. The monitor device 10 then receives the identities and/or network addresses and corresponding categories, for the sites reviewed by the unknown site reviewer 230 since the last download by the monitor device. The computer 210 can be programmed to transmit site categorizations not only for the requests originating on a particular network 100 but also for other networks 100 as well. It has been found that there is a significant likelihood that if a user of one network 100 requested access to a site 252, a user of another network 100 will request access to the same site. There are a number of reasons for this phenomenon, including the fact that workers of different companies tend to communicate with one another about particular web sites of mutual interest. In addition, certain sites 252 may be significantly popular over a broad cross-section of users that includes users of different networks 100. Moreover, the time relevance of some sites 252 may make the sites desirable to users of different networks, such as a news website during a significant news event. The data indicating the newly categorized sites 252, along with that previously stored in the site categorization library 70, can be used to monitor and block access of a user to restricted site(s). The site restrictions can be set in the monitor device 10 for the network 100 by data indicating the site category in correspondence with the users or groups of users and the sites they are permitted and prohibited from accessing via respective computing devices 1.

As an added advantage, the site categorization data updates provided by the update computer 210 can be used to distribute modifications and upgrades in the software for the monitor device 10 as well as terms of license agreements, to the monitor device 10. The specifics of these features will be described in further detail hereinafter.

VII. Exemplary Embodiment of the Monitor device

Monitor device 10 serves as a pass-by filter of network traffic, particularly requests to access external sites 252. It also provides the ability to selectively block specific network traffic to prohibited sites 252. Additionally, it provides the ability to transmit uncategorized sites to the unknown site reviewer 230 for categorization. Furthermore, the monitor device 10 provides the ability to track and log requests of individual users and groups within a network 100.

As shown in FIG. 2, monitor device 10 is operatively coupled for communication to network 100 at monitor device network connection (“MDNC”) 101. The monitor device 10 can comprise network interface cards (“NICs”) 20, drivers 30, processor 40, memory 42, and bus 44. The processor 40, memory 42, and network interface cards 20 are coupled via bus 44. The memory 42 stores an operating system 46, networking services software 48, packet capture library 50, packet capture software 52, category daemon module 60, site content categorization library 70, content access control data 75, and uncategorized site content data 80. These software modules and data stored in the memory 42 can be retrieved and used by the processor 40 to perform the functions of the monitor device 10. The network interface cards 20 can comprise monitor NIC 22 and administration NIC 24. The drivers 30 can comprise two separate modules 32, 34.

The MDNC 101 is preferably coupled in the network 100 at a network position relatively near the computing device(s) 1 of respective user(s). For example, MDNC 101 is preferably located in the network 100 between firewall 4 and the computing device(s) 1. Additionally, MDNC 101 can be placed at a position in the network 100 that is between proxy server 2 and the computing device(s) 1. This prevents the possibility of a request from the computing device(s) 1 resulting in transfer of a web page without the monitor device 10 being able to determine whether the requested content is in a category that is permitted by the external network usage policy enforced by the monitor device.

Alternatively, if the monitor device 10 is coupled in the network 100 at a network position after the proxy server 2 in relation to the computing device(s) 1, then the cache of the proxy server 2 can be cleared to prevent unauthorized and/or inappropriate access to a web page from a prohibited site 252 contained in the cache of the proxy server 2.

MDNC 101 is typically a switch or hub. Usually, it is preferable to use a switch. The switch should be set to permit a ‘promiscuous’ connection with the monitor device 10, as discussed below. One skilled in the art will appreciate that promiscuous mode allows a network device to intercept and read each network packet that arrives in its entirety. This mode of promiscuous operation is sometimes used in the art in connection with a so-called “snoop server” that captures and saves all packets from network traffic for analysis.

One skilled in the art will appreciate that some switches are not designed to allow a promiscuous connection. In this case, the switch can be replaced in the network 100 with a different switch with a promiscuous mode of connection. Alternatively, in those situations in which replacement of the switch is not feasible, a hub with promiscuous mode capability can be coupled to the network 100 and used as the MDNC 101.

VII.A. Network Interface Cards

As previously mentioned, the network interface card(s) 20 can be implemented as two separate cards 22, 24 called the ‘monitor NIC’ and ‘admin NIC’ cards, respectively. It should be apparent to one skilled in the art that the functions of the cards as described herein may be consolidated onto one card, or may be distributed to more than two cards.

VII.A.1. Monitor NIC

Monitor NIC 22 is operatively coupled to the network 100 and functions to provide by-pass monitoring of the network traffic. The method of operatively coupling the monitor NIC 22 to the network 100 is the MDNC 101 that is a switch or a hub or the like, as previously mentioned. Monitor NIC 22 is set to receive data packets from a promiscuous mode MDNC device 101 and to pass these packets to the processor 40 for use in monitoring and analyzing the communication traffic on the network 100. In a local area network (“LAN”), promiscuous mode is a mode of operation in which every data packet transmitted is received and read by a network adapter. An adapter is a physical device that allows one hardware or electronic interface to be adapted, or accommodated without loss of function, to another hardware or electronic interface. In a computer, an adapter is often built into a card that can be inserted into a slot on the computer's motherboard. In this present embodiment, the card is a Network Interface Card (“NIC”). The card adapts information that is exchanged between the computer's microprocessor and the devices that the card supports.

It is important to note that promiscuous mode must be supported by each network adapter as well as by the input/output driver(s) 32 and the host operating system 46. As an example of a possible driver for use in the monitor device 10, if LINUX RedHat is used as the operating system 46, ‘Libpcap’ can be used as the driver 32. As an alternative to using an existing driver such as ‘Libpcap’, one skill in the art will appreciate that an individual driver can be coded to specifically fulfill the requirements of the adapter or NIC card used in the monitor device 10. Monitor NIC 22 can be used to selectively monitor or “sniff” P Packets, TCP Packets, and/or UDP packets. If a desired packet is found it is passed to the NIC driver(s) 32. Alternatively, the monitor NIC 22 can pass all network traffic to the monitor device 10. Normally, if promiscuous mode is used, the network 100 will not allow transmission from the receiving monitor NIC 22. Therefore, another NIC card such as the admin NIC 24 is required for transmission of requests, commands, and data from the monitor device 10 to the network 100 because the monitor NIC 22 is used in promiscuous mode.

VII.A.2. Admin NIC

The admin NIC 24 is designed to transmit requests, commands, and data from the monitor device 10 to the network 100 for transmission to a computing device 1 and/or the Sites 250, 251, 252 via the network 200. The admin NIC 24 can also provide a network interface for receiving control requests, commands, and data from a computing device 1 operated via a network administrator or other person charged with responsibility for implementation of the rules of the Internet usage policy established for the network 100. Admin NIC 24 is set in non-promiscuous mode, meaning that it does not receive all network traffic, but only that originating from a network administrator and/or particular computing device 1, or the computer 210 of the master site 250. More specifically, the admin NIC 24 can respond to the IP address of a particular computing device 1 used as a network administration terminal. Alternatively, the admin NIC 24 can communicate with a network administrator that is authenticated by the monitor device or other server, such as the proxy server 2, of the network 100. Authentication of the network administrator can be performed using a login procedure in which the network administrator enters a user name and/or password to verify this person's identity to the monitor device or network server. As with monitor NIC 22, admin NIC 24 uses NIC driver(s) 32 to translate requests, commands and data in network traffic into a form usable by the monitor device's operating system 46.

VII.B. Drivers

The driver(s) 30 can comprise NIC driver(s) 32 for interfacing with the NIC cards 22, 24 and other drivers 34. The driver(s) 34 can be used to interface or communicate with other devices including peripherals. These peripheral devices can include keyboards, monitors, printers, storage devices, and other input/output devices. Such devices can be useful for configuring, operating, and controlling the monitor device 10. These peripherals may also be used to generate a display on a monitor or to store data for purposes of maintaining a record of external network usage. As one skilled in the art will appreciate, the driver(s) 30 can be included as a part of the operating system 46 or, as shown in FIG. 2, can be separate software modules that are distinct from the operating system 46. In either case, the driver operates to interface communications from the network interface cards 20 to the operating system 46, and vice versa.

VII.C. Basic Software

The monitor device's memory stores an Operating System (“O/S”) 42, Networking Services 48, and a Packet Capture Library 50. These components are designed to perform the necessary functions to allow the hardware of Monitor device 10 to execute the functions disclosed herein.

VII.C.1. Operating System

The operating system 46 is preferably a Linux operating system. In the present embodiment RedHat Linux Version 7.2 is utilized. One skilled in the art will appreciate that the operating system 46 must be compatible with the hardware of monitor device 10. Additionally, one skilled in the art will appreciated that other operating systems can be substituted. Options for the operating system 46 include Windows® 95, 98, 2000, NT, ME, XP, other Linux and Unix versions, and MacOS including MacOS X.

VII.C.2. Networking Services

Networking services 48 are software modules that provide basic network services such handling of network traffic in accordance with FTP, HTTP, NNTP, SNMP, Telnet, MP3, and Real Audio, etc. The networking services 48 can also implement security and control of access to resources or devices accessible within the network 100. The networking services 48 are standard and well known to those of ordinary skill in this technology.

VII.C.3. Packet Capture Library

Packet capture library (“PCL”) 50 provides the ability to detect desired packets. A packet is the unit of data that is routed between an origin and a destination on an external network 200 such as the Internet or any other packet-switched network. In the operation of transmitting data (for example, an e-mail message, HTML document, Graphics Interchange Format file, Uniform Resource Locator request, and the like) from one device to another on the Internet, the Transmission Control Protocol (“TCP”) layer of TCP/IP divides the file into elements of an efficient size for routing. Each of these packets is separately numbered and includes the Internet address of the destination. The individual packets for a file may travel different routes through the Internet. After arrival at the destination, the packets are reassembled to reconstruct the original file by the TCP layer at the destination device. The term ‘datagram’ may also be used to describe a unit of data transmitted over the Internet. A ‘datagram’ is similar to a ‘packet’. In the User Datagram Protocol (UDP), the term datagram instead of packet is commonly used to refer to a unit of data. A datagram is, to quote the Internet's Request for Comments 1594, “a self-contained, independent entity of data carrying sufficient information to be routed from the source to the destination computer without reliance on earlier exchanges between this source and destination computer and the transporting network.” The term has been generally replaced by the term packet. In the present application the word packet will include datagrams. Datagrams or packets are the message units that the Internet Protocol uses and that the Internet transports.

VII.C.3.a. Description of a Packet

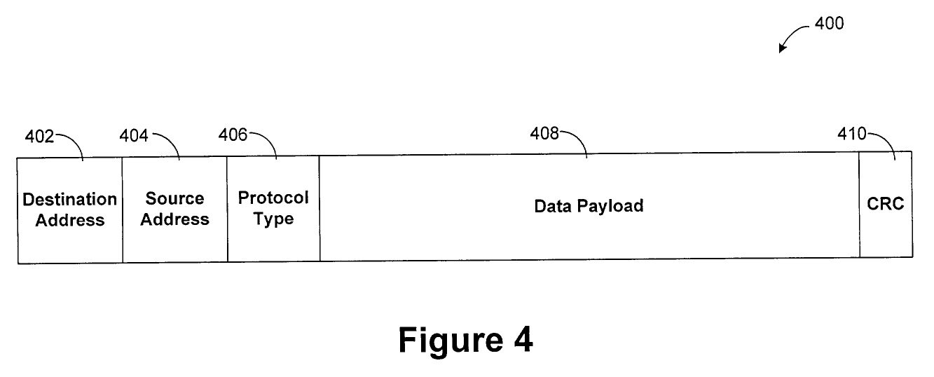

As shown in FIG. 4, packet 400, which is for example an Ethernet packet, typically contains segments including destination address 402, source address 404, protocol type 406, data payload 408 and cyclic redundancy check (CRC) and checksum 410. Destination address 402 is a six-byte segment identifying the destination node address of the receiving device. Source address 404 is a six-byte segment identifying the source node address of the transmitting device. Protocol type 406 is a two-byte segment identifying the protocol utilized in relation to Packet 400. Data payload 408 contains the ‘information’ or ‘data’ of the packet. In the present invention, the ‘information’ or ‘data’ to be monitored relates to requests to access a content site via the external network. The request can be internet protocol (IP) requests contained in a single packet or packet stream. The request can be in various formats such as streaming audio, streaming video, FTP, HTTP (e.g., GET and POST requests), NNTP, SNMP, Telnet and the like. The CRC and checksum 410 provide for error detection and correction.

VII.C.3.b. Packet Capture Software

Packet capture software 52 of FIG. 2 uses packet capture library 50 to detect a request to access a site 252 on the external network 200 within the packet 400. It is important to note that single packets are reviewed thereby avoiding the overhead associated with multi-packet assembly. This can be accomplished because in most protocols a site request is contained within a single packet. Hence, the processor 40 need not assemble packets into entire data strings or files to determine that a request for a resource at a site 252 external to the network 100 has been made by a user of a computing device 1.

VII.C.3.c. Category Daemon

The category daemon 60 analyzes a data packet containing a request to access a site 252 on the external network 200 to determine the identity of the requesting user and/or computing device as well as the identity of the requested site content. The category daemon 60 determines this information to establish whether the user and/or computing device 1 is authorized to access such site content under the rules of the external network usage policy enforced by the category daemon. In this process, the category daemon 60 uses site content categorization library 70 to determine the category of the requested site content to compare against the site content access control data 75 that determines the site content categories each user and/or computing device 1 is permitted to access. If the requesting user and/or computing device 1 is permitted to access the site content, then the monitor device 10 drops the data packet under analysis, and proceeds with analysis of the next data packet. Conversely, if the requested content is prohibited to the user and/or the computing device 1, the category daemon 60 will block access to the prohibited site 252. In attempting to determine the category of a site requested by a data packet, the category daemon 10 may determine that the requested site is not categorized in the site content categorization library 70. In this circumstance, the category daemon 60 permits the request to pass to the network 200 but also stores the identity and/or network address of the requested site 252 as uncategorized site content data 80 for further analysis. At intervals, the category daemon 60 transmits the uncategorized site content data 80 to the computer 210 of the master site 250. The computer 210 forwards the uncategorized site content data 80 to the unknown site content reviewer 220 for categorization. The unknown site content reviewer 220 categorizes the content of the requested site 252 and returns its identity and/or network address and site content category to the computer 210. The computer 210 transmits this data to the monitor device 10 for storage in the site content categorization library 70. The resulting content categorization data is thus made available to the monitor device 10 for categorization of site content of a previous request, as well as a transpiring or future request.

FIG. 4 is a relatively specific flowchart of exemplary processing performed by the packet capture software 52 and category daemon software 60 upon execution of these modules by the processor 40. As shown in FIG. 4, in step 300 the packet capture software 50 receives a packet for processing. In step 302, the packet's data payload 408 is examined to determine if it is a request for content hosted at a content site 252 external to the network 100. For example, an ‘HTTP GET’ request within data payload 408 of packet 400 is a request for access to an external site by a computing device 1. Those skilled in the art will appreciate that other similar requests can be determined as requests to access an external content site. This includes IP requests including, without limitation, FTP OPEN, Telnet OPEN, and various similar requests in streaming audio, streaming video, NNTP, SNMP, and other protocols.

If the result of decision step 302 is a determination that packet 400 is not a site content request packet, in step 304 the packet 400 is dropped by the monitor device 10. As previously mentioned, when a packet is dropped, the ‘original’ packet on network 100 continues to the specified node. The activity of the monitor device 10 is ‘transparent’ to user of the computing device 1 in this instance because the packet examined by the monitor device is a duplicate or mirror image of the packet traveling on the network 100. Therefore, if the duplicate packet used by the packet capture software 50 is dropped or discarded in step 304, the original packet nonetheless continues to the destination site 252 without interference. For example, if a packet 408 contains an ‘HTTP GET’ request, the original packet 400 continues from the computing device 1 from which it originated to the destination site 252 over network 200 for execution. If the request is valid and permitted at the site 252 that receives it, that site will respond accordingly. Therefore, if the request is for a web page, the requested page is sent by the site 252 to the computing device 1 so that the user can view the page. From the perspective of the computing device 1 and its user, there is no interruption or delay in the processing of the site request unless category daemon 60 acts prior to the receipt of the requested page to block it. It should therefore be understood that the monitor device 10 does not introduce delay into the time needed to carry out a site request. Advantageously, the monitor device 10 is thus not a limiting factor in the quality of service provided to a network user.

If decision step 302 determines that packet 400 includes a site request, in step 306, the packet capture software 50 transmits the packet 400 to the category daemon 60. In step 308 the category daemon software 60 receives the transmitted packet from packet capture software 50. In step 310 the category daemon software 60 examines its data payload 408 to determine if site data is included therein. If decision step 310 determines that site data is included within packet 400, then in step 312, the site data is extracted from the packet payload 408. However, if decision step 310 finds that such site data is not within packet payload 408, then in step 314, the site data is extracted from the destination address 402 of packet 400.

One skilled in the art will appreciate that an alternative to step 314 if decision step 310 fails to find site data in data payload 408, is to simply drop the packet. Due to the relative size of data payload 408, the probability of a site request being present without site data in the packet payload 408 is not likely to be significant. Following extraction in either step 312 or step 314, the site data can be normalized in step 316. Normalization generally involves converting the site data into a set format. Because the site data extracted from the packet 408 is likely to be in a standardized format, the normalization step 316 may not be necessary. In the present embodiment, the site data includes the URL and the first level or directory (if any) thereafter. For example, if the site requested in the payload is ‘www.bigsite.com/sports’, then the site is ‘www.bigsite.com’ and the first level directory is ‘/sports’. If second and higher level directories are present in the site data, second and any higher-level element is truncated from the string. For example, ‘www.bigsite.com/sports/usconference/somecollege’ is categorized the same as ‘www.bigsite.com/sports.’ If no first level directory is listed, it is categorized separately than the same site with first level directories. For example, ‘www.bigsite.com’ is categorized differently than ‘www.bigsite.com/sports’. One skilled in the art will appreciate that categorization can be limited to the site alone, without including the directory, or can include subdirectories beyond the first level directory. However, in many circumstances, it is desirable to balance the storage requirements of listings to the categorization of sites. Sites may contain different content in sub-directories, but if each subsequent directory is listed and categorized, the data required to be stored grows exponentially. Therefore, it is generally preferred to limit the listing to the first directory level. To summarize, for purposes of this disclosure, the ‘site data’ is preferred to be the domain name along with the first level directory or the domain name without a top-level directory.

In step 318 the site data is translated into an index that can be a pseudo-random code or hash. More specifically, the alphanumeric string of the site data is subjected to a hash function to generate an index or key corresponding to a slot of a hash table. The hash or key is generally of uniform length and smaller in length than the largest string of site data. Accordingly, the translation step 318 can be used to achieve significant savings in terms of the amount of memory required to store the site data and the time required to access data in a hash table in a memory fetch operation. Hashing also obscures the site data from being humanly discernible. This feature can be used to protect the privacy of site requests made by users of other networks 100 if stored in the site categorization library 70. In other words, it is generally desirable that a user of a network 100 not be able to determine site requests made by users of other networks 100 by viewing the contents of the site categorization library 70.

In step 320, a decision is made to determine whether the index is stored in the SCL 70. If the index is found in SCL 70 in decision step 320, then the category daemon software 60 reads the site categorization data corresponding to the index from the SCL 70. In step 330 the site categorization level is compared to the configuration for the user and/or group requesting the site in step 330. Decision step 332 then determines if the user of the computing device 1 is allowed to access the requested site. As previously described, this decision is preferably based on the administrative settings corresponding to the User of the computing device 1. If the user is allowed to access the requested site, then Packet 400 is dropped in Step 370 and the process ends for Packet 400. However, if a User of the computing device 1 is not allowed to access the site, Step 334 preferably sends User of the computing device 1 a pre-configured HTML message informing of the blockage of the site in place of the requested information. This message is preferably contained in a URL providing the Network Usage Policy (“NUP”) of the company.

For example, a sample HTML message can be:

“Access Denied—Please Refer to Your Organization's Network Usage Policy”

Step 336 sends a termination request to the destination site. One skilled in the art will appreciate that this step is not necessary to practice the invention, but providing a termination to the requested site will prevent that site from expending unnecessary overhead and transmission time. Additionally a termination request prevents the transmission of packets to the local network that produces undesirable network traffic. Therefore, one skilled in the art will appreciate that a termination request sent to the requested site, will likely assist in maintaining or even improving QoS of the local network.

Step 338 logs the request of User of the computing device 1. Contained in the log is preferably data indicating (1) the user requesting the site; (2) the site requested; (3) the category of the site; and (4) the date and time of the request. From such logs can be generated reports that will better assist the administrator to enforce policies enacted in relation to network usage. It can also be used to assist the administrator and management thereof in establishing appropriate network usage policies.

Following step 338 the review of Packet 400 is preferably completed.

VII.C.3.d. Review of Unrecognized Site

If in decision step 320 the index is not present in SCL 70, then step 322 stores the index and the corresponding site in Uncategorized Site Data (ISD) 80. Uncategorized site data 80 is later transmitted for categorization by Unknown site reviewer 230. Once Unknown site reviewer 230 creates a categorization for the site and that categorization is populated in SCL 70 preferably through an Update Computer 210, the log of Step 338 will then preferably be modified to reflect the category of the site requested by User of the computing device 1.

Step 326 preferably then sends ISD 80 to Unknown site reviewer 230 via Network 200. One skilled in the art will appreciate that step 342 need not be carried out every time step 322 and/or 324 is carried out. In fact, it is preferable to accumulate uncategorized site data and send ISD 80 to Unknown site reviewer 230 at an incremental time period, for example, once a day. However, the incremental time period is not restricted and can be as short as from one millisecond to as long as one year, for example.

VII.D. Administration of Monitor device

Monitor device 10 is preferably subject to administration both locally, for example through utilization of a monitor and input devices such as a keyboard and mouse, and remotely via a connection on the intranet, Network 100. It is preferable that remote connections directly to Monitor device 10 from the extranet, e.g. Network 200 is not be allowed for security reasons.

As shown in FIG. 2, Administration NIC 24 is connected to Network 100 through MDNC 101a. Admin NIC 24 is utilized to configure Monitor device 10. In addition, Admin NIC 24 transmits Incremental Site Data (“ISD”) 80 to Unknown Site Reviewer (“USR”) 220 and receives data to update Site Categorization Library (“SCL”) 70.

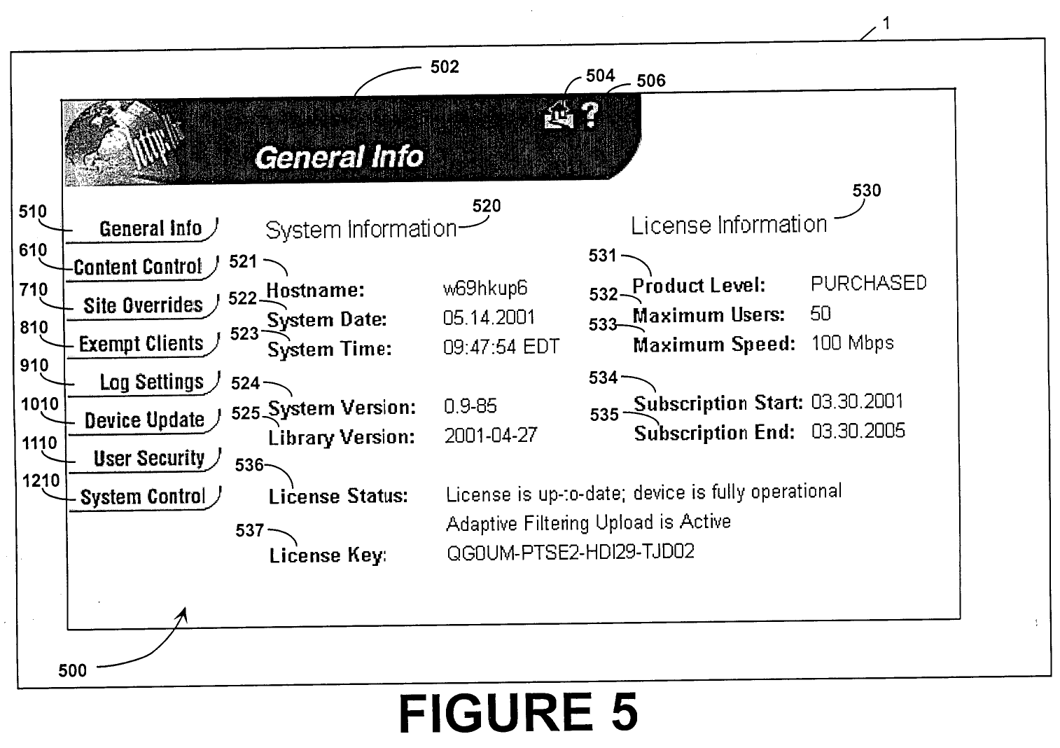

As shown in FIGS. 5-12, the administrator accesses Monitor device 10 to configure it. Multiple pages are provided for separate aspects of administration functions.

Each page preferably provides links to the other pages through link buttons; General Info 510, Content Control 610, Site Overrides 710, Exempt Clients 810, Log Settings 910, Device Update 1010, User Security 1110, System Control 1210. Additionally each page contains Home Link 504, and Help Link 506. It is preferable to program these links as a template to save program and processing overhead.

VII.D.1. General Information

As shown in FIG. 5, General Information Screen 500 is signified by General Info Header 502. General Info 500 shows System Information 520 and License Information 530.

VII.D.1.a. System Information

System Information 520 includes Hostname 521. In the present embodiment, as shown in FIG. 5, this is given the name “w69hkup.” Hostname 521 preferably assists the administrator in identifying Monitor device 10.

System Date 522 is shown in the present example as “05.14.2001.” System Time 523 is shown in the present example as “09:47:54 EDT.” System Date 522 and System Time 523 are utilized, among other reasons, to assist in scheduling updates to Site Categorization Library 70, transference of the collected data in Incremental Site Data 80, and assist in establishing License Status 530.

System Version 524 is shown in the present example as 0.9-85 and Library Version 525 is shown in the present example as 2001-04-27. System Version 524 is utilized in establishing the current update version of the program code and the like to assist in establishing the need for potential updates. Library Version 525 is utilized in establishing the date of the Site Categorization Library 70 to assist in establishment of the need for updates. Both. System Version 524 and Library Version 525 can also be used to assist in “trouble shooting” and providing support and instruction for the application.

VII.D.1.b. License Information

License Information 530 is utilized to ensure the required contractual obligations associated with the software and service agreements are satisfied.

Product Level 531 provides the status of the type of license agreement. In the present example in FIG. 5, the type of license agreement is displayed as “PURCHASED.” Other levels may include “BETA,” “TEMPORARY,” “TESTING” and the like.

Maximum Users 532 provides the number of seat licenses of machines that can be monitored under the license agreement. In the present embodiment this is listed as 50.

Maximum Speed 533 provides the maximum speed or transmission rates that the license allows. In the present embodiment the maximum speed is set at 100 Mbps. For example a “scaled back” version may be limited to 10 Mbps.

Subscription Start 534 provides the date of valid subscription to utilize the license. In the present embodiment the date is listed as “03.30.2001.”

Subscription End 535 provides the ending date of the subscription when the use of the software and services is no longer validly licensed. In the present embodiment this date is “03.30.2005.”

License Status 536 provides information including: whether the license is up to date, whether the device is operational, and whether the Flexible Access Filtering is operational.

License Key 537 provides information regarding the license key. Preferably this key is unique to each and every user and provides a built in security feature regarding the license. In the present embodiment License Key 537 is “QGOUM-PTSE2-HDI29-TJD02”.

VII.D.2. Content Control

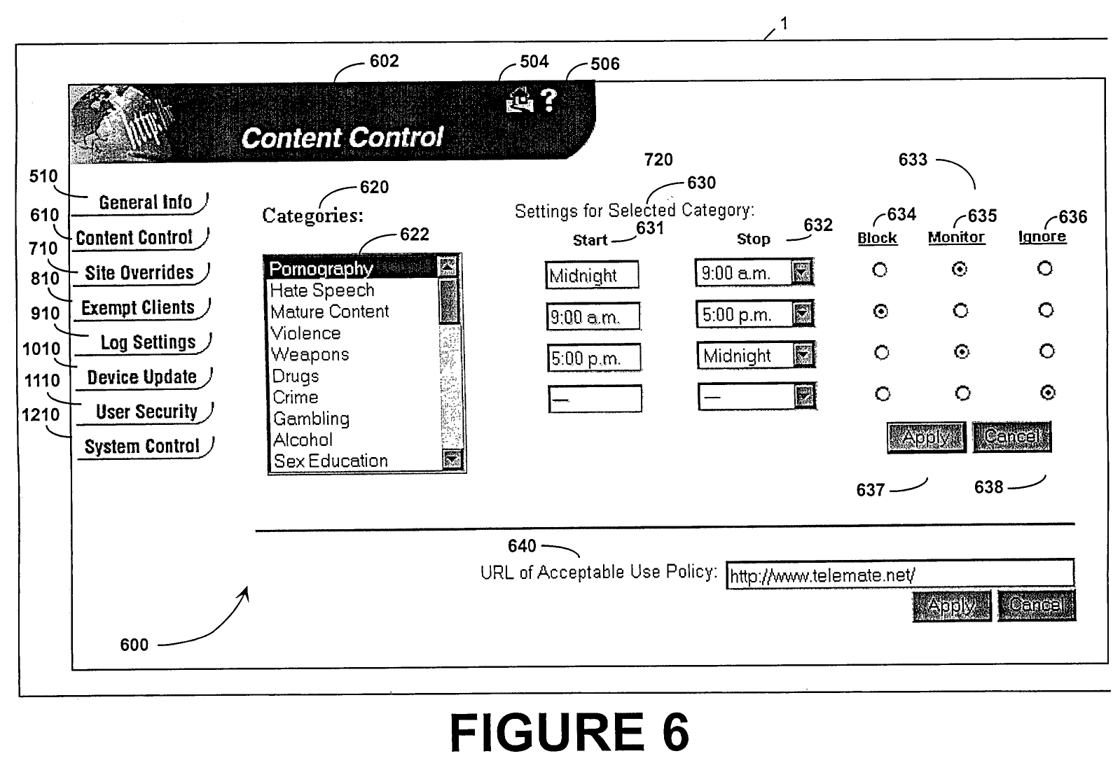

As shown in FIG. 6, Content Control Screen 600 provides information regarding the control of categories to block and/or monitor. Additionally Content Control Screen 600 allows the administrator to select categories to block and the ability to block categories at certain times of the day, monitor categories at certain times of the day, or ignore Internet requests during certain times of the day.

Content Control Header 602 provides indication to the user of the control screen viewed. Categories Listing 620 indicates the location of the categories selected. Category Selection Field 622 preferably contains a menu of website categorizations. In the present embodiment the menu of categories are taken from Table 1—Filtering Content Categories.

The categories are individually linked to unique settings. These unique settings are shown in Settings for Selected Categories 630 that provides Start Time 631 and Stop Time 632. For each corresponding Start Time 631 and Stop Time 632 are preferably radio buttons to allow for selection of either Block Button 634, Monitor Button 635, or Ignore Button 636.

Start Time 631 and Stop Time 632 are preferably pull down menus that allow the administrator to select the respective times.

In the example shown in FIG. 6, the administrator has elected to monitor surfing of sites classified as Pornography from Midnight until 9:00 AM and from 5:00 PM until Midnight. During the hours of 9:00 AM to 5:00 PM the administrator desires to block such surfing. Therefore Midnight is entered into the first Start Time 631 and 9:00 AM is entered into the first Stop Time 632. One skilled in the art will appreciate that entering of these times can be facilitated in multiple ways, including pull down menus or simply entering times. The first Monitor Button 635 is then selected (or checked) to signify the during this time period Monitor device 10 is to Monitor web surfing of Pornographic material. In the present example monitoring entails viewing and logging the surfing activity. During a monitoring period a User of the computing device 1 will be able to access sites categorized as pornography, but such access will be noted and logged by Monitor device 10.

The time 9:00 AM is entered into the second Start Time 631 and 5:00 PM is entered into the second Stop Time 632. In the example of FIG. 6 the second Block Button 634 is selected. Because these parameters are entered into the second line, a User of the computing device 1 is blocked by Monitor device 10 from viewing sites categorized as pornography. During this time period of 9:00 AM until 5:00 PM when a User of the computing device 1 requests such a site request Monitor device 10 recognizes such viewing and sends a cancel request to the requested site and redirects the browser of the computing device 1 to a URL of a web page or screen hosted by the network 100 to post the Network Usage Policy 640 for Monitor device 10. This URL preferably provides notice to User of the computing device 1 that the site is restricted during this time period and that the request has been logged.

“5:00 PM” is entered into the third Start Time 631 “Midnight” is entered into the third Stop Time 632. The third Block Monitor Button 635 is selected. Again, in the example of FIG. 6 the User of the computing device 1 will be able to view sites categorized as pornography between the hours of 5:00 PM and Midnight, but such activity will be logged by Monitor device 10.

The fourth line is left blank in the present embodiment with the fourth Ignore Button 636 checked. If Ignore Button 636 is selected, Monitor device 10 allows viewing of the corresponding category, and does not log such viewings/requests. However, in the example of FIG. 6, because no start and end times have been specified, selection of the Ignore Button 636 had no effect in this case. However, selection of such button 636 could be effective if valid corresponding start and end times were specified.

Selection of Apply Button 637 applies the settings selected to Monitor device 10. Selection of Cancel Button 638 clears the selections entered. In the example of FIG. 6 selection of Cancel Button 638 does not clear settings previously set in Monitor device 10, but only clears selections not yet applied to Monitor device 10.

VII.D.3. Site Overrides

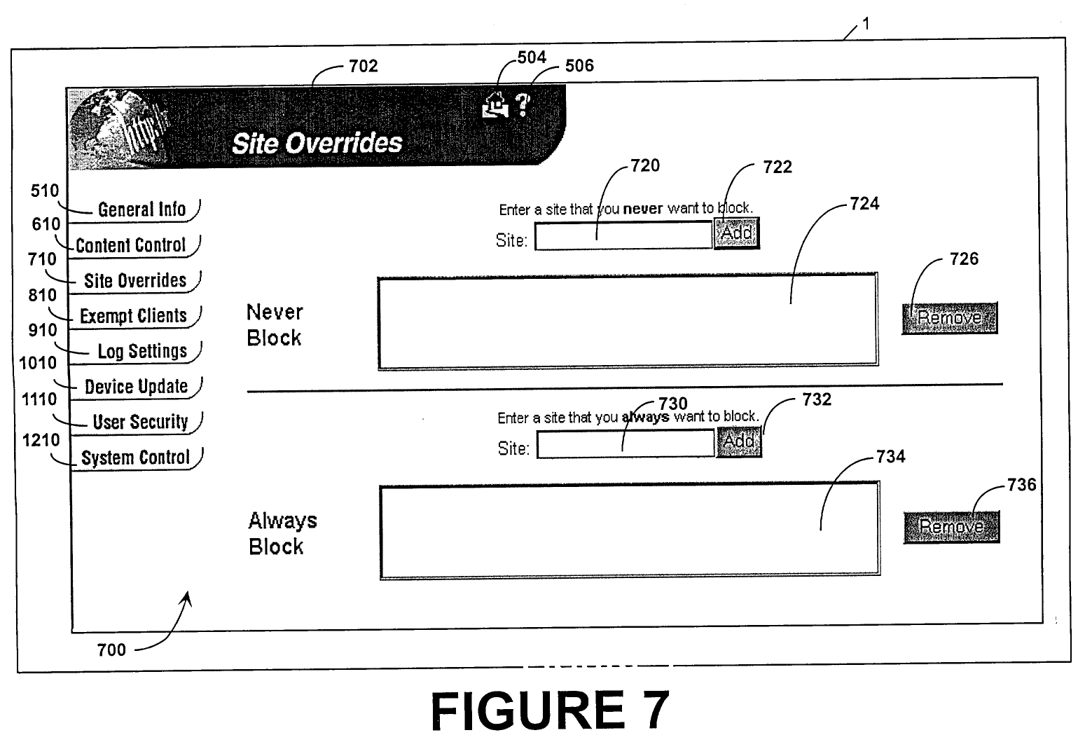

As shown in FIG. 7, Site Overrides Screen 700, signified by Site Overrides Header 702, allows the administrator to customize the blocking function. The administrator can type a site name/address into Never Block Entry field 720 and add the site by clicking on Never Block Add Button 722. The site will be displayed in Never Block List 724. If the administrator desires to removed the site from Never Block List 724 by selecting the site to be removed in Never Block List 724 and clicking on Remove Never Block 726.

An administrator may desire to block the general category of sports, but allow access to a specific university's football team's Web site. For example, the administrator may allow access to a particular sport site http://www.football.com/. To do this the administrator would enter “www.football.com” into Never Block Entry Field 720 and add the site by clicking on Never Block Add Button 722. The site “www.football.com” would then be listed in Never Block List 721.

Additionally, if an administrator believes a site is erroneously and/or inappropriately blocked, the administrator can add that site to Never Block List 724 so that it is no longer blocked.

Conversely, the administrator can block certain sites. The administrator can type a site name/address into Always Block Entry Field 730 and add the site by clicking on Always Block Add Button 732. The site will be displayed in Always Block List 734. If the administrator desires to remove the site from Always Block List 734, the administrator can select the site to be removed in Always Block List 734 and click on Remove Always Block Button 736.

For example if the Administrator allows viewing of sport categories, but wishes to prevent Users of computing devices 1 from viewing a particular sports website such as “someuniversityfootballteam.com”, this can be done by entering this domain name into Always Block Entry 730 and adding the site by clicking on Always Block Add Button 732. The site “someuniversityfootballteam.com” is then listed in Always Block List 734.

One skilled in the art will appreciate that the always block feature can be used to block access of the User of the computing device 1 to sites for a multitude of reasons. These reasons include blocking a site miscategorized or not yet categorized. When this is done, the site is blocked until Monitor device 10 is updated.

VII.D.4. Exempt Clients

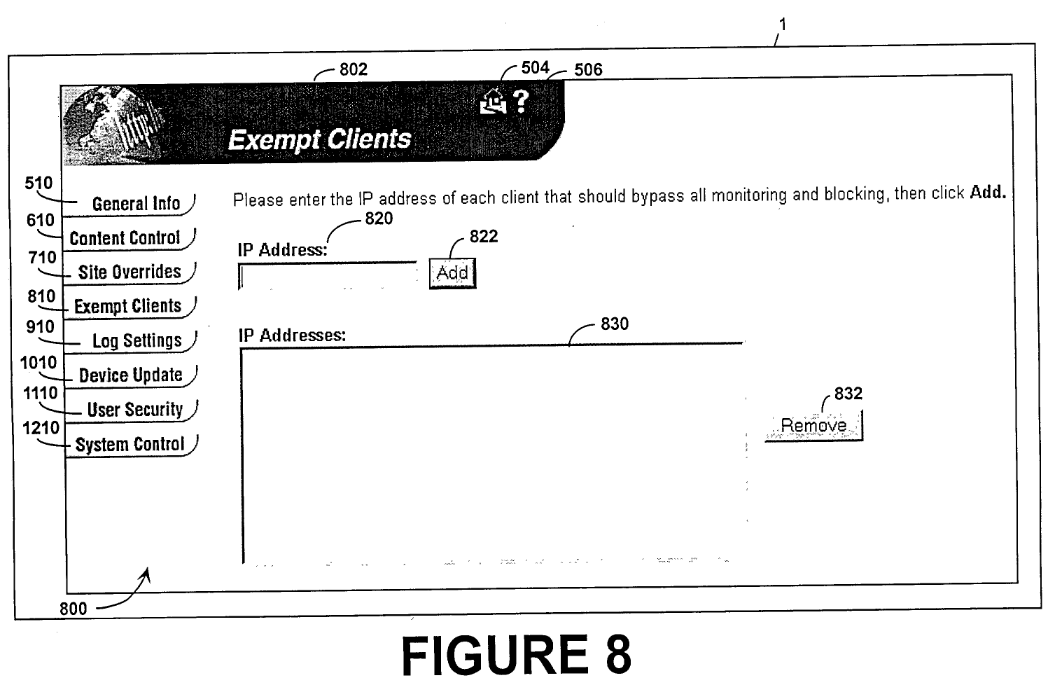

As shown in FIG. 8, one or more employees or Users of the computing devices 1 may require free access to Network 200. The Administrator can accomplish this quickly and easily using Exempt Clients Interface 800. The administrator enters the computing device's IP address into IP Address Exempt field 820 and clicks Add Exempt Button 822. The added IP address will be displayed in Exempted IP Addresses List 830. Individual exempted IP Addresses can be removed at any time by selecting the desired IP Address to be removed in Exempted IP Addresses List 830 and clicking on Removed Exempt Button 832. It is preferable that when a User's computing device 1 is exempted, the site requests made by the User with that computing device will not be recorded or logged in any way.

VII.D.5. Log Settings

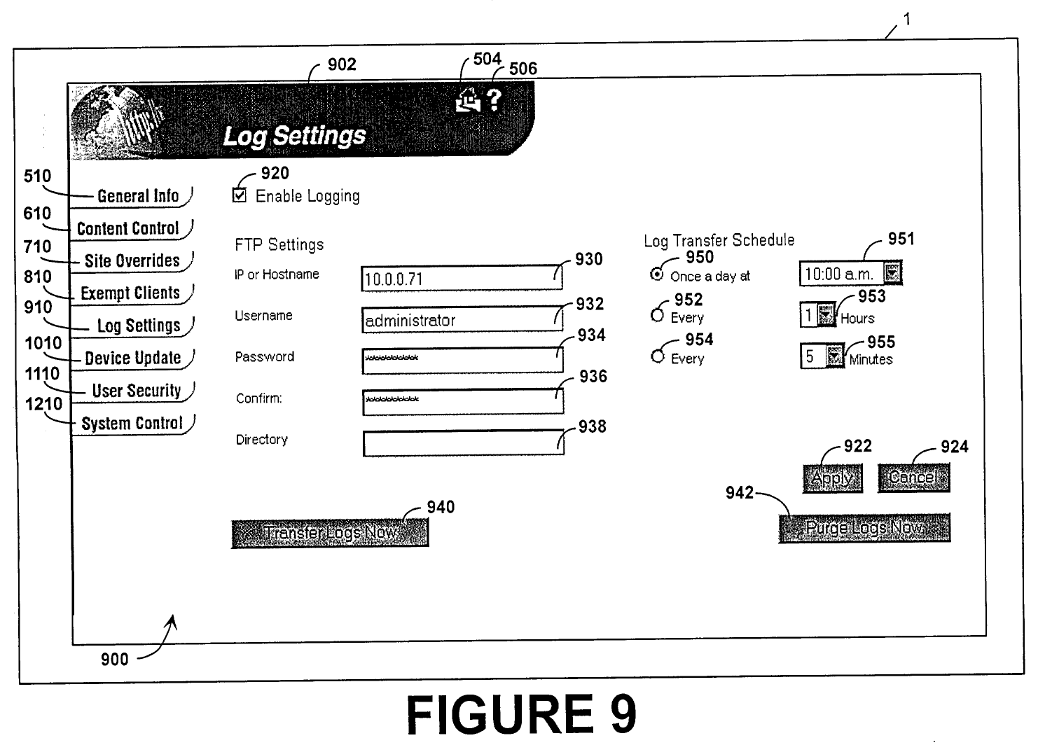

As shown in FIG. 9, the log settings screen or web page 900 designated by header 902 permits the administrator to set various parameters pertaining to the logging of site requests and uploading of uncategorized site data 80 from the monitor device 10 to the master site 250. Enable logging button 920 must be selected or ‘clicked on’ using the cursor of a user interface provided by the administrator's computing device 1 to interact with the monitor device 10 to affect its settings. The screen 900 includes an FTP Settings group of fields 930, 932, 934, 936, 938. The IP or Hostname field 930 permits the administrator to enter the IP or host address to which the log file containing uncategorized site data 80 is to be transmitted for review and analysis by the unknown site reviewer 230. Fields 932, 934, 936 are used to authenticate a person as having administrative authority to change the log settings using screen 900. The User name field 932 permits the administrator to enter a user name. The Password and Confirm fields 934, 936 permit the administrator to enter a password twice to ensure that the administrator entered the intended password. The user name and password entered in fields 932, 934, 936 are used by the monitor device 10 to authenticate the administrator and to determine whether the administrator has authority to set or change the log settings pertaining to uploading of uncategorized site data 80 to the unknown site reviewer 230. If the administrator lacks such authority, the monitor device 10 will not permit setting or changing of any log setting in response to the administrator's control actions using computing device 1. Conversely, if the monitor device 10 confirms the administrator is authorized to set or change the log setting using the entered user name and password, the administrator can use the computing device 1 to set or change the log settings. Using the field 938 the administrator can specify the directory of the monitor device 10 at which the log file containing uncategorized site data 80 is located. The administrator can use the computing device 1 to press the Transfer Logs Now Button 940. Upon activation of the Button 940, the monitor device 10 retrieves the log file containing uncategorized site data 80 from the directory specified in field 938 and uploads this file to the unknown site reviewer 230 either directly or via computer 210 at the master site 250. Alternatively, the administrator can specify a Log Transfer Schedule using fields 950-955. More specifically, the administrator can use the computing device 1 to select the ‘Once a day at’ Button 950 and can use the pop-down menu 951 to select a desired time of day at which to send the log file containing uncategorized site data 80 to the unknown site reviewer 230. Alternatively, or in addition to a daily upload, the administrator can use the pop-down menu 951 to select the ‘Every’ radio button 952 to opt to send the log file containing uncategorized site data 80 to the unknown site reviewer 230 at a time interval of one or more hours using the pop-down menu 953. Furthermore, the administrator can select the ‘Every’ radio button 954 and enter a desired number of minutes using pop-down menu 955 to set the monitor device 10 to transmit the log file containing uncategorized site data 80 to the unknown site reviewer 230 at a time interval of a selected number of minutes using the pop-down menu 955. Hence, the administrator can send the log file containing uncategorized site data 80 to the unknown site reviewer 230 on a daily, hourly, and/or minutely basis. By selecting the Apply button 922 any parameters set in the fields 930, 932, 934, 936, 938, 950-955 is transmitted over the network 100 to the monitor device 10 for storage in its memory and is used to set the log transfer schedule to be used by such appliance to transmit the log file containing uncategorized site data 80 to the unknown site reviewer 230.

By selecting the Cancel button 924 the Log Settings screen 902 is closed without saving any data appearing in the Log Transfer Schedule fields 930, 932, 934, 936, 938, 950-955. The administrator can use the computing device 1 to activate the Purge Logs Now button 942. Selection of the button 942 causes the computing device 1 to transmit a signal to the monitor device 10 causing such appliance to delete any uncategorized site data 80 contained in the log file.

VII.D.6. Device Update

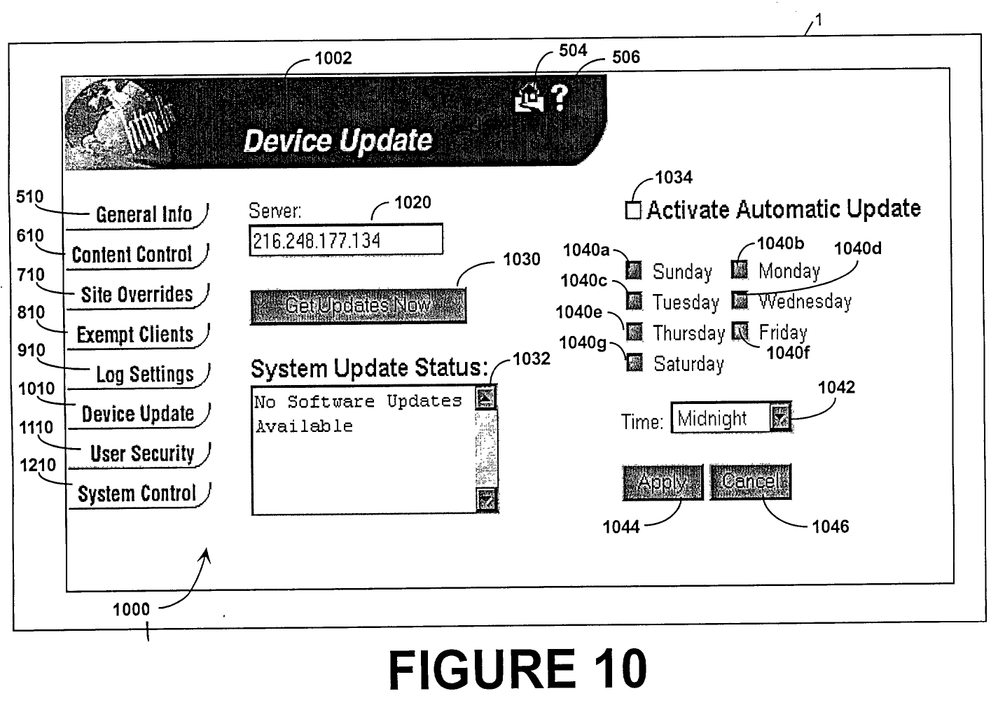

Using the screen or web page 1001 of FIG. 10, which is indicated as Device Update screen 1002, the Administrator can program the Monitor device 10 to receive site categorization data from the Master Site 250 to update its library 70. The administrator enters the field 1020 the IP address of the computer 210 at the Master Site 250. In response to activation of software button 1030, the Monitor device 10 uses the entered IP address to transmit a request for updates to the site categorization library 70 via the external network 200. The computer 210 acts upon the request by determining whether the requesting User Site 260 is authorized and/or licensed to receive site categorization data updates as of the time and date of the request. If not, the computer 210 rejects the request and sends a message to the Administrator indicating the reason for the rejection. Conversely, if the computer 210 determines that the User Site 260 is authorized to receive updates, the computer 210 retrieves the requested updates to the site categorization data from Master Site Categorization List 221 stored in the data storage unit 220 and transmits this site categorization data to the Monitor device 210. The Monitor device 10 receives and stores the site categorization data for use in determining whether user requests are authorized under the Network Usage Policy.

Field 1032 can be used to display information transmitted from the Master Site 250 to the Monitor device 10 to indicate the System Update Status. For example, such information can be used to display text indicating any updates to the software executed by the Monitor device 10. The information indicated in the field 1032 can also be used to indicate approach of the expiration of the term of a license for use of the Monitor device 10, system 1000, and/or software used therein.

The Device Update screen 1001 has an Automatic Update feature. By checking box 1034, the system administrator can activate the Monitor device 10 to receive site categorization data updates on a scheduled basis. Using check boxes 1040a-1040g, the Monitor device 10 can select one or more days of the week upon which to receive updates. In addition, the administrator can use the pop-down menu 1042 to select the time of day at which the user desires to receive scheduled updates. By selecting the Apply button 1044, the Monitor device 10 is set to request updates of site categorization data from the Master Site 250 via the network 200 according to the schedule entered. The Automatic Updates feature can be canceled by selecting the Cancel button 1046.

VII.D.7. User Security

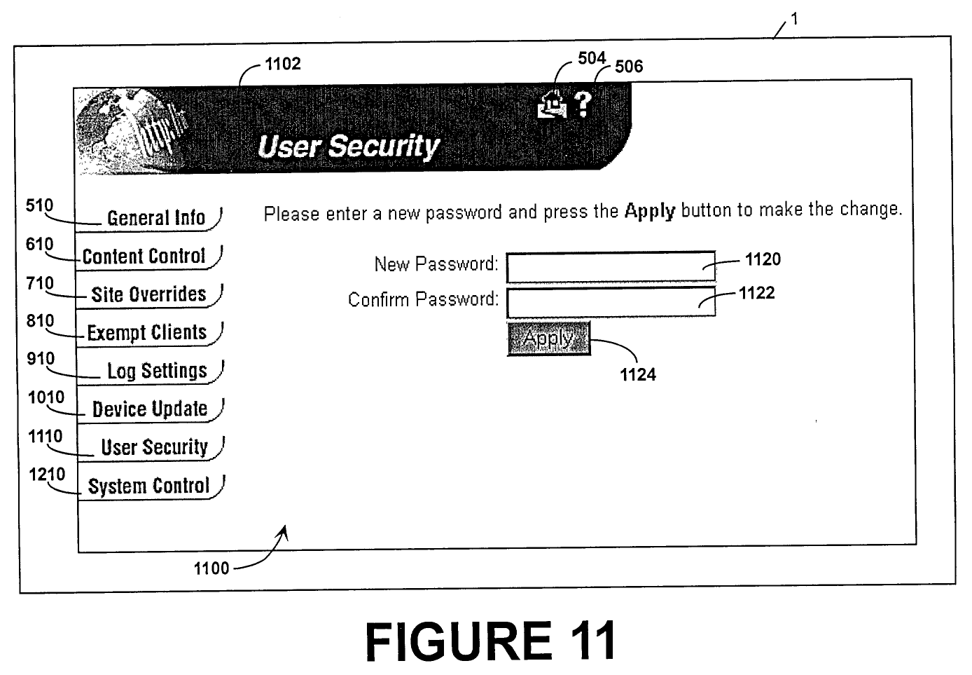

FIG. 11 is a view of a screen or web page 1100 identified as the User Security screen 1102. As with previously described screens, the screen 1102 can be displayed by a computing device 1 that interacts with the monitor device 10 via the network 100. The screen 1102 permits an administrator to enter a new password or change a password for use in authenticating a person as having administrative authority over the monitor device 10. The administrator enters the password in the New Password field 1120 and again in the field 1122 and presses the Apply button 1124. Upon selection of the Apply button 1124 the computing device 1 transmits the entered passwords over the network 100 to the monitor device 10. The monitor device 10 compares the received passwords entered in fields 1120, 1122. If these two passwords match, the monitor device 10 stores the new password from field 1120 in correspondence with the Administrator's user name. Conversely, if the passwords entered in fields 1120 and 1122 do not match, then the monitor device 10 does not store the password and generates a message indicating that the password has been entered incorrectly and requesting the person to reenter the password using the computing device 1.

VII.D.8. System Control

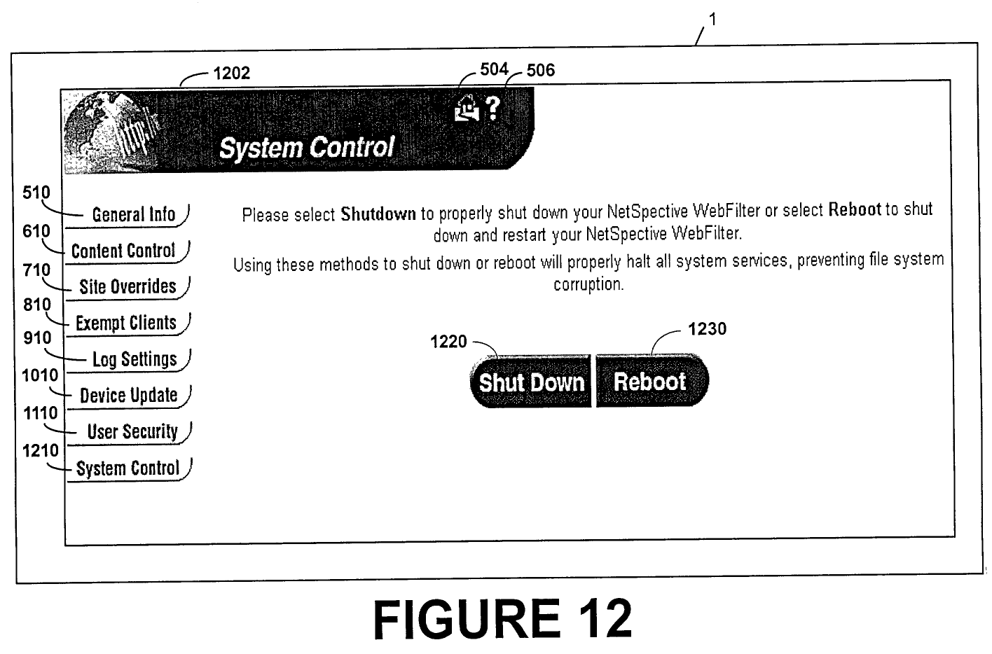

FIG. 12 is a view of a System Control screen 1200 designated as such by header 1202. This screen can be used to either shutdown or reboot the software executed by the monitor device 10 in a manner that ensures that the uncategorized site data 80 and logged user activity data is not lost. More specifically, the Shut Down Button 1220 can be activated by the administrator with the computing device 1 to shutdown the monitor device 10. Alternatively, selecting the Reboot Button 1230 transmits a signal from the computing device 1 to the monitor device 10 to cause such appliance to reload and execute the packet capture software 52 and the category daemon 60. The software modules that effect shut down or reboot of the system do so in a manner that ensures that all system services are properly halted to prevent corruption of the SCL 70, Site Access Control Data 75, and Uncategorized Site Data 80.

VII.E. Summary of Monitor device and Software

As stated above Monitor device 10 monitors activity on Network 100. It is preferable for Monitor device to monitor outbound traffic only (i.e. traffic from Network 100 to Network 200).

Monitor device 10 initially only reviews Data Payload 408. If Data Payload 408 contains a “sought after” request, that packet is further reviewed as discussed above. It is preferable to base this review on categorizations. Monitor device 10 provides a recordation of uncategorized sites found within Payload 408. Because the system 1000 categorizes only User-requested web sites, sites that have not been requested are not stored in the Site Categorization Library 70. The uncategorized site(s) is one that the User of the computing device 1 has actually accessed, or for which the user has requested access. This greatly reduces the storage of “un-surfed” sites in Site Categorization List 70 or the like. Additionally, the present invention provides the ability to quickly recognize new sites that are accessed and provide an expedited means of categorizing such sites.

VIII. Exemplary Embodiment of the FAF System

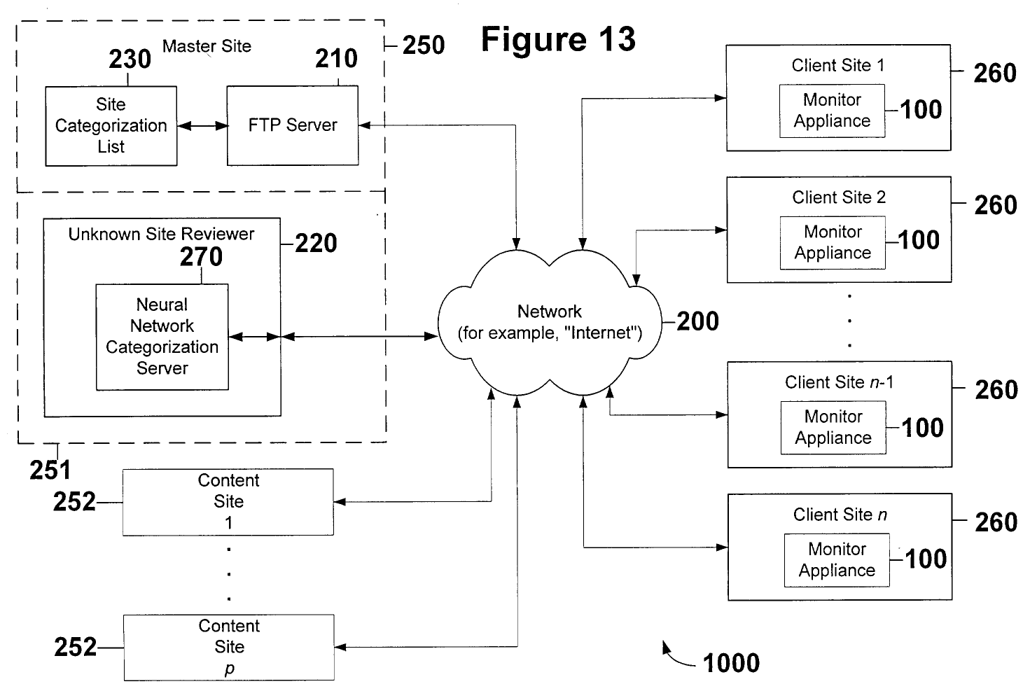

As shown in FIG. 13, the Flexible Access Filtering (“FAF”) System preferably has a plurality, n, of User Sites 260. Each User Site 260 is operatively connected with Master Site 250.

VIII.A. Plurality of User Sites

As discussed above each User Site 260 runs independently of Master Site 250 and of each other User Site 260. Therefore one skilled in the art will appreciate that the connection between a User Site 260 and the Master Site 250 need not be a permanent connection. In fact, the connection between Master Site 250 and User Site 260 need only exist when periodically transferring data between Master Site 250 and User Site 260, or vice versa.

VIII.B. Master Site

As shown in the present embodiment as depicted in FIG. 13, Master Site 250 preferably has an Unknown site reviewer 230, a Site Categorization List 221 and an FTP Server or Update Computer 210. One skilled in the art will appreciate that Master Site 250 need not be at a single location or physical site. As defined herein Master Site 250 is simply a collection of elements that are operatively connected in order to achieve the aspects and features of the present invention. Also, as with other elements described herein, the terms ‘server’ and ‘computer’ as applied to unit 210 are used broadly to encompass any device capable of executing computer code to perform the functions of such elements described herein.

VIII.B.1. Site Categorization List

Master Site Categorization List 221 contains the master list of all of the actively categorized sites as well as the site currently being categorized. If Master Site 250 receives an “unreviewed” site from a User Site 260, Master Site 250 will first determine if the site is contained in Site Categorization List 221.

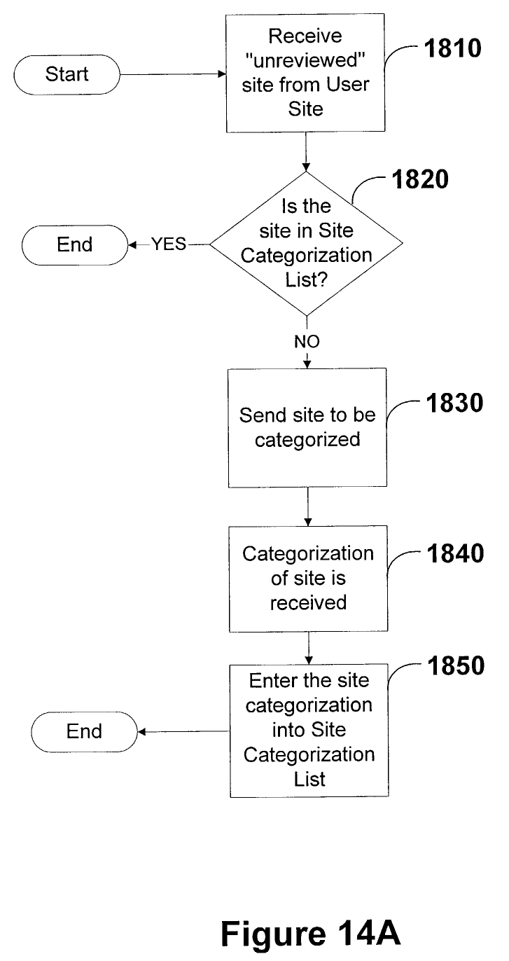

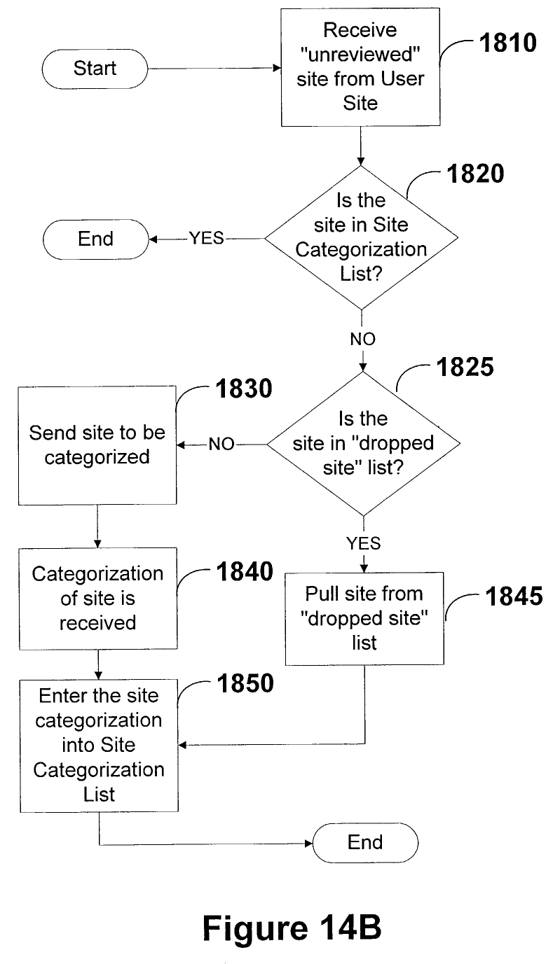

Turning now to FIG. 14A, a method for updating the Master Site Categorization List 221 is depicted. In the first step 1810, Master Site 250 receives an “unreviewed” site from User Site 260. As previously described, a User Site 260 sends an “unreviewed” site not present in the Site Categorization Library 70 of a User Site 260 to the Master Site 250 for categorization. However, another of the User Sites 260 may have previously sent the same “unreviewed” site and that site may be either under review or already categorized. Therefore decision step 1820 determines whether the site is in Site Categorization List 221. If the determination of step 1810 is affirmative, then the process is ended. This will be true regardless if the site is finished being categorized or if the site is undergoing categorization. However if the determination of step 1820 is negative, then in step 1830 the Master Site 250 sends the site to be categorized to the Unknown site reviewer 230, which carries out the site categorization. The Master Site 250 can transmit data identifying the site to be categorized either directly or via network 257 to the Unknown site reviewer 230.

The next step 1840 is done when the categorization of the site is received. After being received, the next step 1850 is to enter the site categorization into Site Categorization List 221.

At this point the method of FIG. 14A ends.

One skilled in the art will appreciate that not all web pages and sites are static in nature. In reality these sites might change over time. Therefore it may be preferable to set a default “expiration” date for a web site. When the site is “expired” it is preferably re-evaluated by the unknown site reviewer 230 to ensure proper categorization.

Additionally, it may in some cases be preferable to receive data regarding those sites requested by users of a User Site's network 100 so that it can be determined which sites that are contained in Site Categorization Library 70,and therefore in Site Categorization List 220, have not been requested by User of the computing device 1 of that User Site 260. If it is determined that none of User Sites 270 have had a User of the computing device 1 request that site within a period of time, then it may be preferable to remove that site from Site Categorization Library 70 and Site Categorization List 220. Furthermore, it might be advantageous to store “dropped” site in a “dropped site listing.” Therefore, if a site is to be reviewed by Unknown site reviewer 230, if a “dropped” listing is available, it could first be reviewed prior to categorization.

FIG. 14B depicts an alternative method of updating the Master Site Categorization List 221. In the first step 1810 the Master Site 250 receives an “unreviewed” site from User Site 260. In step 1820 a decision is made to determine whether the site requested by a user is in the Site Categorization List 221 due to previous categorization of this site. If the answer is “Yes”, then the categorization data for the site is retrieved and the process is ended. This is true regardless of whether the site is finished being categorized or if the site is undergoing categorization.

However, if the result of the determination of step 1820 is “No” then decision step 1825 determines whether the site is in the dropped site list 223. If the answer is “Yes” then in step 1845 the categorization data pertaining to the site under analysis is retrieved from the “dropped site” list stored at the master site 230. In step 1850 the site categorization data and site identification data are stored in Site Categorization List 220. Following this the process ends.

If the decision step 1825, which asks “Is the site in Site Categorization List 221,” produces a “No” result, then in step 1830 the site is sent to be categorized. The computer 210 of the master site 250 in this case transmits the unknown site data or index to the unknown site reviewer 230 for categorization. The unknown site reviewer 230 reviews and categorizes the received site and transmits site identification data along with site categorization data to the computer 210 of the master site 250. In step 1840 the computer 210 of the Master Site 250 receives the site categorization data identifying the site(s) and corresponding category(ies) and stores this data in the Master Site Categorization List 221 in step 1850. Thereafter, the method of FIG. 14B ends.

One skilled in the art will appreciate that if a site to be reviewed is found in a “dropped site listing” for a period of time no User of the computing device 1 of an of the User Sites 270 requested that particular site. Therefore it was “dropped” and saved in the “dropped site listing.” This decreases the respective sizes of the Site Categorization Library 70 as well as Site Categorization List 221. In decreasing the size of the Site Categorization Library 70 the time needed to complete review is also decreased as the number of sites to handle is decreased. However, if that “dropped” site is once again requested, then instead of forcing a complete review of the site, that site's information, including the site's categorization, can be obtained from the “dropped site listing.” However, if the site is not available, then it can be reviewed.

VIII.B.2. Unknown Site Reviewer

Unknown site reviewer 230 provides the ability to categorize site which are not present in the Site Categorization List 221 or which are “expired” either in the Site Categorization List 221 or “dropped site” list 223. As mentioned previously, it is preferable to use an automated process to categorize site data. This can include use of keywords and to categorize the requested content. Alternatively, site content categorization can be performed using a neural network that reviews the requested site content and categorizes such site content. Site categorization can also be performed using non-automated processes such as human review of requested content sites to determine the category for such site. Other methods now known or that may be developed in the future may be used to categorize site content in the present invention.

VIII.C. FTP Server

FTP Computer 210 is preferably available for connection with User Sites 260. FTP Server will provide updates of SCL 70 as well as software updates and licensing updates to Monitor device 10. It is preferable that each User Site 260 be given a unique login. This will facilitate the ability to direct specific files, upgrades, and license updates/revocations to specific User Sites 260.

### CONCLUSION

Finally, it will be understood that the preferred embodiment has been disclosed by way of example, and that other modifications may occur to those skilled in the art without departing from the scope and spirit of the appended claims. For example, although it is generally preferred to use a monitor device 10 in a network 100, it should be appreciated that any or all of the functions performed by the monitor device 10 can be carried out by another device in such network, such as the server 2. The functions of the computer 210 of Master Site 250 and the Unknown site reviewer 230 can also be distributed among different computing machines, or performed by different types of computing machines than those disclosed in the preferred embodiments. Security measures such as encryption and decryption of data can be used by sites and/or devices communicating via the external network 200. All of these alternatives and modifications of the disclosed system, apparatuses and methods are considered to be included within the scope of the appended claims.

What is claimed is:

1. A monitor device coupled to receive requests to access content sites on an external network by users of respective computing devices on an internal network, the monitor device determining the categories of the requested content sites associated with the requests and blocking access to the content sites based on the respective categories of the content sites that the users are not authorized to access, the monitor device storing uncategorized site data indicating content sites requested by users that have categories not determined by data stored by the monitor device, the monitor device transmitting the uncategorized site data to a master site for categorization.

2. A monitor device as claimed in claim 1 wherein the monitor device determines the categories of the content sites from a site categorization library downloaded from the master site via the external network.

3. A monitor device as claimed in claim 2 wherein the monitor device downloads the site categorization library at determined time intervals.

4. A monitor device as claimed in claim 3 wherein the site categorization library is downloaded at time intervals in a range from one millisecond to one year.

5. A monitor device as claimed in claim 1 wherein the monitor device logs requests of the users of the computing devices in association with the categories of the requested content sites.

6. A monitor device as claimed in claim 1 wherein the monitor device determines whether the users are authorized to access content sites using site access control data that defines the categories that the users are authorized to access.

7. A monitor device as claimed in claim 6 wherein the site access control data defines the categories of content sites each user is authorized to access.

8. A monitor device as claimed in claim 1 wherein the monitor device uploads the uncategorized site data at determined time intervals.

9. A monitor device as claimed in claim 1 wherein the monitor device uploads uncategorized site data at time intervals in a range from one millisecond to one year.

10. A monitor device as claimed in claim 1 wherein the monitor device accumulates uncategorized site data for transmission to the master site for categorization.

11. A monitor device as claimed in claim 1 wherein the master site transmits the uncategorized site data to an unknown site reviewer for categorization, the unknown site reviewer categorizing content sites indicated by the uncategorized site data to generate site categorization data, the unknown site reviewer supplying the uncategorized site data to the master site, the master site storing the site categorization data in a site categorization library supplied to the monitor device via the second network for use in categorizing subsequent requests by users for access to content sites.

12. A monitor device as claimed in claim 1 wherein the first network is an intranetwork.

13. A monitor device as claimed in claim 1 wherein the external network is “the Internet.”

14. A method as claimed in claim 1 wherein the request is in the form of a packet.

15. A method as claimed in claim 1 wherein the requests are Internet protocol (IP) requests.

16. A monitor device storing site access control data indicating at least one privilege of a user of a first network to access a category of content site via a second network, the monitor device further storing a site categorization library received from a master site via the second network, the site categorization library indicating a content category of at least one content site, the monitor device using the site access control data and site categorization library to determine whether a request generated by a user of a computing device coupled to the first network is authorized to access a content site via the second network, the monitor device permitting the request to proceed if the user is authorized to access the content site, and the monitor device preventing the user of the computing device from accessing the content site if the user is not authorized to access the content site, the monitor device storing uncategorized site data indicating content sites requested by users that have categories not determined by data stored by the monitor device, the monitor device transmitting the uncategorized site data to a master site for categorization.

17. A monitor device as claimed in claim 16 wherein the site categorization library is downloaded at periodic intervals from one millisecond to one year.

18. A monitor device as claimed in claim 16 wherein the monitor device uses a site categorization library listing site identification data in correspondence with site categorization data, and site access control data listing user identification data in correspondence with site categorization data so as to indicate whether a user is authorized to access a category of content site.

19. A monitor device as claimed in claim 18 wherein the monitor device determines that it does not have stored site categorization data indicating the category of the requested content site, the monitor device transmitting site data indicating the requested content site to a master site for categorization.

20. A monitor device as claimed in claim 18 wherein the monitor device determines that it does not have stored site categorization data indicating the category of the requested content site, the monitor device storing site data identifying the requested content site as uncategorized site data.

21. A monitor device as claimed in claim 20 wherein the monitor device transmits the uncategorized site data to the master site via the second network for categorization of the requested content site.

22. A monitor device as claimed in claim 21 wherein the monitor device transmits the uncategorized site data to the master site at determined time intervals.

23. A monitor device as claimed in claim 22 wherein the monitor device transmits the uncategorized site data to the master site at time intervals determined from one millisecond to one year.

24. A monitor device as claimed in claim 16 wherein the monitor device monitors network traffic from the computing device in the first network to determine whether a transmission from the computing device is a request for access to the content site.

25. A monitor device as claimed in claim 16 wherein the monitor device is coupled to the first network with a monitor device network connection (MDNC).

26. A monitor device as claimed in claim 25 wherein the MDNC comprises a switch.

27. A monitor device as claimed in claim 25 wherein the MDNC comprises a hub.

28. A monitor device as claimed in claim 16 wherein the first network is an intranetwork.

29. A monitor device as claimed in claim 16 wherein the second network is “the Internet.”

30. A master site coupled to communicate with a plurality of user sites via a network, the master site comprising a computer coupled via the network to the user sites, the computer receiving uncategorized site data from the user sites and causing site categorization data to be generated for the user sites based thereon, the computer transmitting the site categorization data for the plurality of user sites to each user site for use in determining whether a user of a computing device at the user site is authorized to access a content site.

31. A master site as claimed in claim 30 wherein the computer transmits site categorization data to monitor devices of the user sites in a site categorization library file.

32. A master site as claimed in claim 29 wherein the computer receives uncategorized site data from the monitor device via the network, the master site coupled to supply the uncategorized site data to an unknown site reviewer to determine the category of at least one content site identified by the uncategorized site data to produce site categorization data, the master site transmitting the site categorization data as determined by the unknown site reviewer, to the monitor device via the network for use by the monitor device to determine the category of the content site for a subsequent request from the user to access the content site.

33. A master site as claimed in claim 29 wherein the master site comprises the unknown site reviewer.

34. A master site as claimed in claim 32 wherein the unknown site reviewer comprises a neural network for determining the category of the content site identified by the unknown site reviewer.

35. A master site as claimed in claim 29 wherein the uncategorized site data comprises the universal resource locator (URL) and first directory if any of the network address of the content site, and the unknown site reviewer uses the URL and first directory if any to determine the category of the content site requested by the user.

36. A master site as claimed in claim 29 further comprising:
a data storage unit coupled to the computer, the data storage unit storing a master site categorization list having site categorization data for all content sites categorized by the unknown site reviewer.

37. A master site as claimed in claim 29 wherein the master site logs the date and time of receipt of site categorization data for the content site from the unknown site reviewer, and after expiration of a determined time from receipt of the site categorization data for the content site, the master site deletes the site categorization data for the content site from the master site categorization list and stores the site categorization data in a dropped site list.

38. A master site as claimed in claim 36 wherein the master site searches the dropped site list first for the category of the content site requested the user of a computing device before transmitting the known site data to the unknown site review for analysis.

39. A system for use with at least one content site accessible via an external network, the system comprising:
a plurality of user sites each having a monitor device, a server, and at least one computing device coupled in communication via an internal network, the monitor device coupled to the internal network to monitor communications of the computing device to the server coupled to the external network to receive requests to access content sites via the external network, the monitor devices determining the categories of the requested content sites based on site categorization libraries stored at the user sites and determining whether the users are authorized to access the categories of requested content sites based on site access control data stored at the user sites, the monitor devices storing any site data identifying any content sites not found in the site categorization libraries as uncategorized site data; and
a master site having a computer and a data storage unit, the computer coupled to the external network to receive uncategorized site data from the servers of the user sites, the master site administering categorization of uncategorized site data to produce site categorization data stored in a master site categorization list in the data storage unit, the computer transmitting the master site categorization list containing site categorization data for requests generated at the plurality of user sites to each of the monitor devices via the external network for storage as the site categorization libraries for use in determining categories of content sites requested by users at the user sites.

40. A system as claimed in claim 39 further comprising:
an unknown site reviewer coupled in communication with the computer via the master site, the unknown site reviewer receiving uncategorized site data from the master site and generating site categorization data based thereon, the unknown site reviewer transmitting the site categorization data to the server of the master site.

41. A system as claimed in claim 39 wherein the master site further comprises an unknown site reviewer coupled in communication with the computer of the master site, the unknown site reviewer receiving uncategorized site data from the computer of the master site and generating site categorization data based thereon, the unknown site reviewer transmitting the site categorization data to the computer of the master site for further transmission to the user site.

42. A system for supporting communications of users to content sites coupled to an external network, the system comprising:
a plurality of user sites coupled to the external network, the user sites having respective monitor devices for monitoring network communications of users of respective internal networks of the user sites for requests to access content sites via the external network, the monitor devices selectively granting authorization to the users to access the content sites based on categories of the content sites, the monitor devices transmitting uncategorized site data identifying uncategorized content sites via the external network; and
a master site coupled to the external network, the master site receiving the uncategorized site data, determining the categories of the content sites identified by the uncategorized site data to generate site categorization data, and transmitting the site categorization data to the user sites for use in determining whether users are authorized to access the content sites.

42. A system as claimed in claim 41 wherein the user sites transmit uncategorized site data at determined intervals.

43. A system as claimed in claim 41 wherein the user sites transmit uncategorized site data at determined intervals in a range from one millisecond to one year.

44. A system as claimed in claim 41 wherein the master site transmits the site categorization data to the user sites for storage as site categorization libraries at determined time intervals.

45. A system as claimed in claim 41 wherein the site categorization libraries are transmitted to the user sites at intervals in a range from one millisecond to one year.

46. A system as claimed in claim 41 wherein the external network is an internetwork.

47. A system as claimed in claim 41 wherein the external network is “the Internet.”

48. A system as claimed in claim 41 wherein the internal network is an intranetwork.

49. A method as claimed in claim 41 wherein the request is in the form of a packet.

50. A method as claimed in claim 41 wherein the requests are Internet protocol (IP) requests.

51. A method comprising the steps of:
a) receiving network communications of users of respective internal networks of user sites for requests to access content sites via an external network;
b) determining if possible at the user sites categories of the requested content sites from site categorization data stored at the user sites;
if the categories of the requested content sites can be determined from the site categorization data at the user sites,
c) determining whether the users are authorized to access respective categories of requested content sites; and
d) blocking users from accessing the requested content sites if the determining of step (c) establishes that the users are not authorized to access respective categories of content sites; and
if the categories of the requested content sites cannot be determined at the user sites,
e) transmitting uncategorized site data identifying the requested content sites whose categories cannot be determined in step (b) from respective user sites to a master site for categorization.

52. A method as claimed in claim 51 further comprising the step of:
f) receiving updated site categorization data at the user sites based on the uncategorized content site data for use in subsequent performance of steps (a) and (b).

53. A method as claimed in claim 51 further comprising the step of:
f) categorizing the uncategorized site data to determine categories of the content sites identified by such data; and
g) transmitting the data identifying the content sites and their respective content categories to the users sites for use in subsequent repeated performance of at least steps (a) and (b).

53. A method as claimed in claim 51 wherein at least step (g) is repeatedly performed at time intervals in a range from one millisecond to one year.

54. A method as claimed in claim 51 wherein at least step (g) is repeatedly performed at time intervals at in a range from one to three days.

55. A method as claimed in claim 51 wherein the monitoring is performed by a monitor device.

56. A method as claimed in claim 51 wherein the replicating of step (b) is performed by a monitor device network connection (MDNC) operating in promiscuous mode.

57. A method as claimed in claim 51 wherein the replicating is performed by a switch.

58. A method as claimed in claim 51 wherein the replicating is performed by a hub.

59. A method as claimed in claim 51 wherein the determining of the step (c) is performed by a monitor device having the site categorization library stored in its memory.

60. A method as claimed in claim 51 wherein the site categorization library stores index data identifying at least one content site in association with site categorization indicating a category of the content accessible on the content site.

61. A method as claimed in claim 51 wherein the index data is derived from a universal resource locator (URL) and first level directory if any of the content site.

62. A method as claimed in claim 51 wherein the index data is in a form that is not in a language comprehensible to a user.

63. A method as claimed in claim 51 wherein the determining of step (d) is performed by the monitor device using site access control data stored therein.

64. A method as claimed in claim 51 wherein the site access control data lists user identification data identifying the user in correspondence with site categorization data indicating at least one category of content site, the correspondence of the user identification data to the site categorization data indicating at least one category of content site that the user is authorized to access.

65. A method as claimed in claim 51 wherein the site access control data is determined and set in the monitor device by an administrator of the user site using a computing device coupled to the first network.

66. A method as claimed in claim 51 further comprising the step of:
g) logging the request of the user in association with the category of content site sought to be accessed.

67. A method as claimed in claim 51 wherein the request is logged by storing user identification data identifying a user in association with site categorization data identifying the category of content site for which access is sought by the user.

68. A method as claimed in claim 67 wherein the request is logged with time and date data stored in association with the user identification data and site categorization data.

69. A method as claimed in claim 51 wherein step (e) is performed by a monitor device that transmits a message to the content site to stop the content site from providing access to the user.

70. A method as claimed in claim 51 wherein step (e) is performed by a monitor device that transmits a redirect message to a web browser of the user's computing device that causes the user's web browser to be directed to a web page advising the user that access to the site is not permitted under the network usage policy of the organization with which the respective internal network is associated.

71. A method as claimed in claim 51 wherein the request is in the form of a packet.

72. A method as claimed in claim 51 wherein the requests are Internet protocol (IP) requests.

73. A system as claimed in claim 51 wherein the external network is an internetwork.

74. A system as claimed in claim 51 wherein the external network is “the Internet.”

75. A system as claimed in claim 51 wherein the internal network is an intranetwork.

76. A method comprising the steps of:
a) receiving requests to access content sites on an external network by users of respective computing devices on an internal network of a user site;
b) determining if possible at the user site categories for the requested content sites associated with the requests based on a site categorization library;
c) determining whether users are authorized to access the categories of content sites based on site access control data; and
d) preventing access to the content sites if the determining of steps (b) and (c) establish that the users are not authorized to access the content sites.

77. A method as claimed in claim 76 wherein, if the categories of the requested content sites cannot be determined in steps (b) and (c) at the user site, the user site stores data identifying the uncategorized content sites as uncategorized site data, the method further comprising the step of:
e) transmitting uncategorized site data identifying the requested content sites whose categories cannot be determined in step (b) from respective user sites to a master site.

78. A method as claimed in claim 77 wherein at least step (e) is repeatedly performed at time intervals in a range from one millisecond to one year.

79. A method as claimed in claim 77 wherein the uncategorized site data is accumulated for transmission to the master site for categorization.

80. A method as claimed in claim 77 further comprising the steps of:
f) categorizing the uncategorized site data to determine categories of the content sites identified by such data; and
g) transmitting the data identifying the content sites and their respective content categories to the users sites for use in subsequent repeated performance of at least steps (a) and (b).

81. A method as claimed in claim 80 wherein at least step (g) is repeatedly performed at time intervals in a range from one millisecond to one year.

82. A method as claimed in claim 76 wherein the monitoring is performed by a monitor device.

81. A method as claimed in claim 76 wherein the replicating of step (b) is performed by a monitor device network connection (MDNC) operating in promiscuous mode.

82. A method as claimed in claim 76 wherein the replicating is performed by a switch.

83. A method as claimed in claim 76 wherein the replicating is performed by a hub.

84. A method as claimed in claim 76 wherein the determining of the step (c) is performed by a monitor device having the site categorization library stored in its memory.

85. A method as claimed in claim 76 wherein the site categorization library stores index data identifying at least one content site in association with site categorization indicating a category of the content accessible on the content site.

86. A method as claimed in claim 85 wherein the index data is derived from a universal resource locator (URL) and first level directory if any of the content site.

87. A method as claimed in claim 85 wherein the index data is in a form that is not in a language comprehensible to a user.

88. A method as claimed in claim 76 wherein the determining of step (d) is performed by the monitor device using site access control data stored therein.

89. A method as claimed in claim 76 wherein the site access control data lists user identification data identifying the user in correspondence with site categorization data indicating at least one category of content site, the correspondence of the user identification data to the site categorization data indicating at least one category of content site that the user is authorized to access.

90. A method as claimed in claim 76 wherein the site access control data is determined and set in the monitor device by an administrator of the user site using a computing device coupled to the first network.

91. A method as claimed in claim 76 further comprising the step of:
g) logging the request of the user in association with the category of content site sought to be accessed.

92. A method as claimed in claim 91 wherein the request is logged by storing user identification data identifying a user in association with site categorization data identifying the category of content site for which access is sought by the user.

93. A method as claimed in claim 91 wherein the request is logged with time and date data stored in association with the user identification data and site categorization data.

94. A method as claimed in claim 91 wherein step (e) is performed by a monitor device that transmits a message to the content site to stop the connection to the content site to prevent the content site from providing access to the user.

95. A method as claimed in claim 94 wherein step (e) is performed by a monitor device that transmits a redirect message to the web browser of a user's computing device to cause the web browser to be directed to a web page that displays a message indicating that access to the requested content site is denied due to the network usage policy of an organization associated with the internal network.

96. A method as claimed in claim 76 wherein the requests are in the form of a packet.

97. A method as claimed in claim 76 wherein the requests are Internet protocol (IP) requests.

98. A method as claimed in claim 76 wherein the external network is an internetwork.

99. A method as claimed in claim 76 wherein the external network is “the Internet.”

100. A method as claimed in claim 76 wherein the internal network is an intranetwork.

101. A medium having software executable by a monitor device to perform the following functions:
a) receiving requests to access content sites on an external network by users of respective computing devices on an internal network of a user site;
b) determining if possible at the user site categories for the requested content sites associated with the requests based on a site categorization library;
c) determining whether users are authorized to access the categories of content sites based on site access control data; and
d) preventing access to the content sites if the determining steps (b) and (c) establish that the users are not authorized to access the content sites.

102. A medium as claimed in claim 101 wherein, if the categories of the requested content sites cannot be determined in steps (b) and (c) at the user site, the software stores data identifying the uncategorized content sites as uncategorized site data, the software further executable by the monitor device to perform the following function:
e) transmitting uncategorized site data identifying the requested content sites whose categories cannot be determined in step (b) from the user site to a master site for categorization.

103. A medium as claimed in claim 102 wherein the software is further executable by the monitor device to perform at least step (e) repeatedly at time intervals in a range from one millisecond to one year.

104. A medium as claimed in claim 103 wherein the software is further executable by the monitor device so that the time interval is selectable by an administrator using the software.

105. A medium as claimed in claim 102 wherein the monitor device accumulates uncategorized site data for transmission to the master site for categorization.

105. A medium as claimed in claim 102 wherein the software is further executable by the monitor device to perform the following function:
f) receiving site categorization data categorizing the content sites requested by users.

106. A medium as claimed in claim 105 wherein the software is further executable by the monitor device so that at least step (f) is repeatedly performed at time intervals in a range from one millisecond to one year.

107. A medium as claimed in claim 101 wherein the determining of the step (b) is performed by a monitor device having the site categorization library stored in its memory.

108. A medium as claimed in claim 101 wherein the site categorization library stores index data identifying at least one content site in association with site categorization indicating a category of the content accessible on the content site.

109. A medium as claimed in claim 108 wherein the index data is derived from a universal resource locator (URL) and first level directory if any of the content site.

110. A medium as claimed in claim 108 wherein the index data is in a form that is not in a language comprehensible to a human user.

112. A medium as claimed in claim 101 wherein the determining of step (d) is performed by the monitor device using site access control data stored therein.

113. A medium as claimed in claim 112 wherein the site access control data lists user identification data in correspondence with site categorization data to indicate categories of content sites the users are authorized to access.

114. A medium as claimed in claim 112 wherein the site access control data is determined and set in the monitor device by an administrator of the user site using a computing device coupled to the first network.

115. A medium as claimed in claim 101 wherein the software is further executable by the monitor device to perform the following function:
e) logging the request of the user in association with the category of content site sought to be accessed.

116. A medium as claimed in claim 115 wherein the request is logged by storing user identification data identifying a user in association with site categorization data identifying the category of content site for which access is sought by the user.

117. A medium as claimed in claim 115 wherein the request is logged with time and date data stored in association with the user identification data and site categorization data.

118. A medium as claimed in claim 115 wherein step (e) is performed by the monitor device executing the software to transmit an abort message to the content site to prevent the content site from providing access to the user.

119. A medium as claimed in claim 115 wherein step (e) is performed by the monitor device executing the software to transmit a redirect message to a web browser of a user's computing device to direct the web browser to a page indicating access to the requested content site is denied under the network usage policy of an organization associated with the user site.

120. A medium as claimed in claim 101 wherein the requests are in the form of packets.

121. A medium as claimed in claim 101 wherein the requests are Internet protocol (IP) requests.

122. A medium as claimed in claim 101 wherein the external network is an internetwork.

123. A medium as claimed in claim 101 wherein the external network is “the Internet.”

124. A medium as claimed in claim 101 wherein the internal network is an intranetwork.

125. An adaptive monitoring system coupled to an external network, the system comprising a plurality of monitor devices for respective internal networks of user sites, the monitor devices selectively blocking access of users to content sites accessible via the external network based on data indicating categories of the content sites requested by users of the internal networks, the monitor devices transmitting data for uncategorized content sites requested by users at the user sites to a master site via the external network for categorization, the master site returning updated data indicating categories of the content sites for requests to access content sites received from the plurality of user sites to each user site's monitor device for subsequent use in determining whether users of the internal networks are authorized to access the content sites.

126. An adaptive monitoring system as claimed in claim 125 wherein the monitor devices selectively block access of users to content sites further based on data indicating the users' privileges to access respective categories of content sites.

127. A monitor device for monitoring requests on an internal network to access content sites via an external network, the monitor device using site categorization data to selectively block access to requested sites based on the content category of the requested sites, the monitor device transmitting uncategorized site data identifying the requests sites over the external network to a master site for categorization.

128. A method comprising the steps of:
a) selectively blocking requests from at least one user of an internal network to access at least one content site via an external network using site categorization data; and
b) transmitting uncategorized site data indicating at least one content site requested by the user not having site categorization data to a master site for categorization.

129. A computer receiving uncategorized site data generated by a plurality of user sites via an external network, the computer causing to be generated site categorization data for the plurality of user sites, the computer transmitting the site categorization data for the plurality of user sites to each user site for use in selectively blocking users' access to content sites based on the site categorization data.

130. A method comprising the steps of:
a) receiving uncategorized site data generated by a plurality of user sites;
b) causing site categorization data to be generated for the plurality of user sites; and
c) transmitting the site categorization data for the plurality of user sites to each user site for use in selectively blocking users' access to content sites based on the site categorization data.
